(19) United States
(12) Patent Application Publication
(10) Pub. No.: US 2022/0263377 A1
(43) Pub. Date: Aug. 18, 2022

(54) ELECTRIC WORK MACHINE

(71) Applicant: MAKITA CORPORATION, ANJO-SHI (JP)

(72) Inventors: Yoshinori SASAKI, ANJO-SHI (JP); Masayoshi TORIHARA, ANJO-SHI (JP); Van Luyen TONG, ANJO-SHI (JP); Takahiro KAWAKAMI, ANJO-SHI (JP)

(21) Appl. No.: 17/597,455

(22) PCT Filed: Jul. 17, 2020
(86) PCT No.: PCT/JP2020/027957

§ 371 Date: Jan. 6, 2022

(30) Foreign Application Priority Data
Aug. 21, 2019 (JP) 2019-151435

(51) Int. Cl. H02K 5/16; H02K 7/116; B24B 23/02; H02K 7/08; H02K 7/14

(52) U.S. Cl. CPC H02K 5/16; H02K 7/116; H02K 7/145; H02K 7/086; B24B 23/02

(57) ABSTRACT

An electric work machine includes: a motor having a stator disposed around a rotor; a stator-holding member, which holds the stator; one or more bearings, which rotatably support(s) the rotor; and one or more bearing-retaining members, which is (are) supported by the stator-holding member in an immovable manner in the radial direction, retain(s) the bearing(s), and is (are) made of a metal. The stator-holding member is made of a material that exhibits a water-absorption coefficient of 1.5 wt % or less at equilibrium in an ambient atmosphere at a temperature of 23° C. and a relative humidity of 50%.

### TECHNICAL FIELD

The present disclosure relates to an electric work machine.

### BACKGROUND ART

In the technical field pertaining to electric work machines, a power tool comprising a motor is known, as disclosed in Patent Document 1.

### PRIOR ART LITERATURE

### Patent Documents

Patent Document 1

Japanese Laid-open Patent Publication 2018-069422

### SUMMARY OF THE INVENTION

### Problems to be Solved by the Invention

A motor comprises a rotor and a stator, which is disposed around the rotor. If the rotor is tilted relative to the stator, then there is a possibility that the rotor and the stator will adversely contact one another.

An object of the present disclosure is to curtail contact between a rotor and a stator.

### Means for Solving the Problems

According to the present disclosure, an electric work machine is provided that comprises: a motor comprising a rotor and a stator, which is disposed around the rotor; a stator-holding member, which holds the stator; a bearing, which supports the rotor in a rotatable manner; and a bearing-retaining member, which is supported by the stator-holding member in an immovable manner in the radial direction, retains the bearing, and is made of a metal; wherein the stator-holding member is made of a material whose water-absorption coefficient at equilibrium in ambient atmosphere at a temperature of 23° C. and a relative humidity of 50% is 1.5 wt % or less.

### Effects of the Invention

According to the present disclosure, contact between a rotor and a stator can be curtailed.

### BRIEF DESCRIPTION OF THE DRAWINGS

FIG. 1 is an oblique view that shows a power tool according to a first embodiment.

FIG. 2 is a side view that shows the power tool according to the first embodiment.

FIG. 3 is a plan view that shows the power tool according to the first embodiment.

FIG. 4 is a front view that shows the power tool according to the first embodiment.

FIG. 5 is a partial front view of the power tool according to the first embodiment.

FIG. 6 is a cross-sectional view that shows the power tool according to the first embodiment.

FIG. 7 is a partial, enlarged, cross-sectional view of the power tool according to the first embodiment.

FIG. 8 is a partial, enlarged, cross-sectional view of the power tool according to the first embodiment.

FIG. 9 is a partial, enlarged, cross-sectional view of the power tool according to the first embodiment.

FIG. 10 is an oblique view that shows a baffle and a stator core according to the first embodiment.

FIG. 11 is an exploded, oblique view that shows a gear housing, a gear-housing cover, the baffle, and the stator core according to the first embodiment.

FIG. 12 is a drawing that shows a modified example of the power tool according to the first embodiment.

FIG. 13 is a drawing that shows a modified example of the power tool according to the first embodiment.

FIG. 14 is an oblique view that shows the power tool according to a second embodiment.

FIG. 15 is a cross-sectional view that shows the power tool according to the second embodiment.

FIG. 16 is a partial, enlarged, cross-sectional view of the power tool according to the second embodiment.

FIG. 17 is an oblique view that shows a holding member and an encircling member according to the second embodiment.

FIG. 18 is an oblique view that shows the power tool according to a third embodiment.

FIG. 19 is a partial, enlarged, cross-sectional view of the power tool according to the third embodiment.

FIG. 20 is an oblique view that shows the gear-housing cover and the holding member according to the third embodiment.

### MODES FOR CARRYING OUT THE INVENTION

Embodiments according to the present disclosure will be explained below, with reference to the drawings, but the present disclosure is not limited thereto. Structural elements of the embodiments explained below can be combined where appropriate. In addition, there are also situations in which some of the structural elements are not used.

In the embodiments, the positional relationships among parts are explained using the terms left, right, front, rear, up, and down. These terms indicate relative position or direction, in which the center of an electric work machine serves as a reference. The electric work machine includes power tools having a motor. In the embodiments, the power tool is a grinder.

In the embodiments, the power tool comprises the motor and a spindle, which rotates using the power generated by the motor. A rotational axis AX of the motor and a rotational axis BX of the spindle are orthogonal to one another. A rotor of the motor rotates about the rotational axis AX. The spindle rotates about the rotational axis BX. The rotational axis AX of the motor extends in a front-rear direction. The rotational axis BX of the spindle extends in an up-down direction.

In the embodiments, a direction parallel to the rotational axis AX of the motor is called an axial direction where appropriate, a direction that goes around the rotational axis AX is called a circumferential direction where appropriate, and a direction that radiates from the rotational axis AX is called a radial direction where appropriate. In addition, in the radial direction, a location that is proximate to or a direction that approaches the rotational axis AX is called inward in the radial direction where appropriate, and a location that is distant from or a direction that goes away from the rotational axis AX is called outward in the radial direction where appropriate.

### First Embodiment

### <Overview of Power Tool>

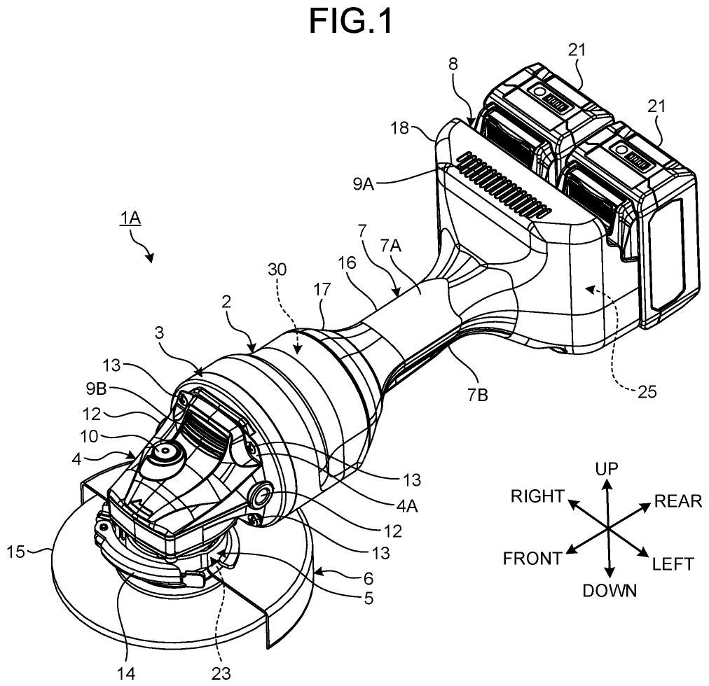

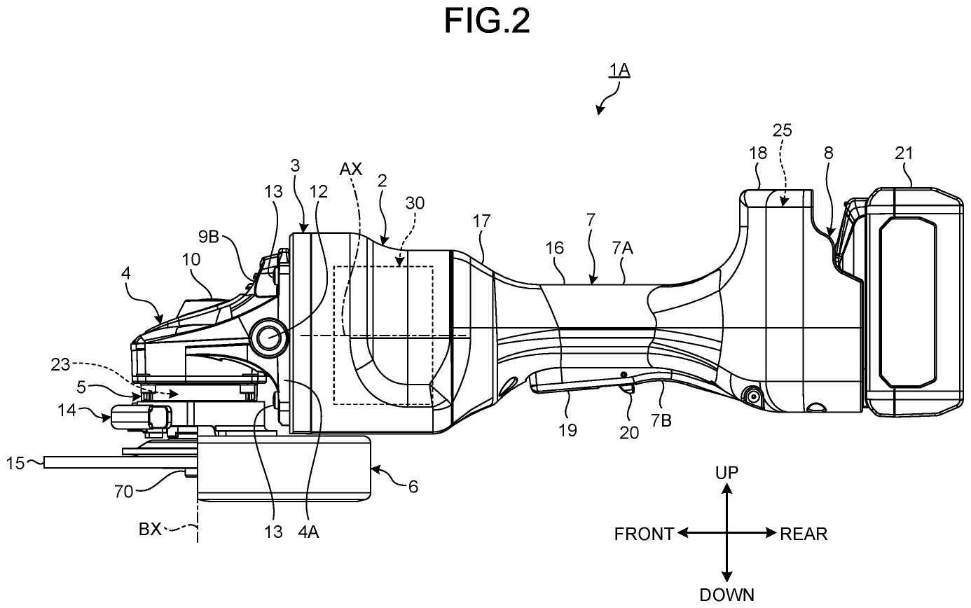

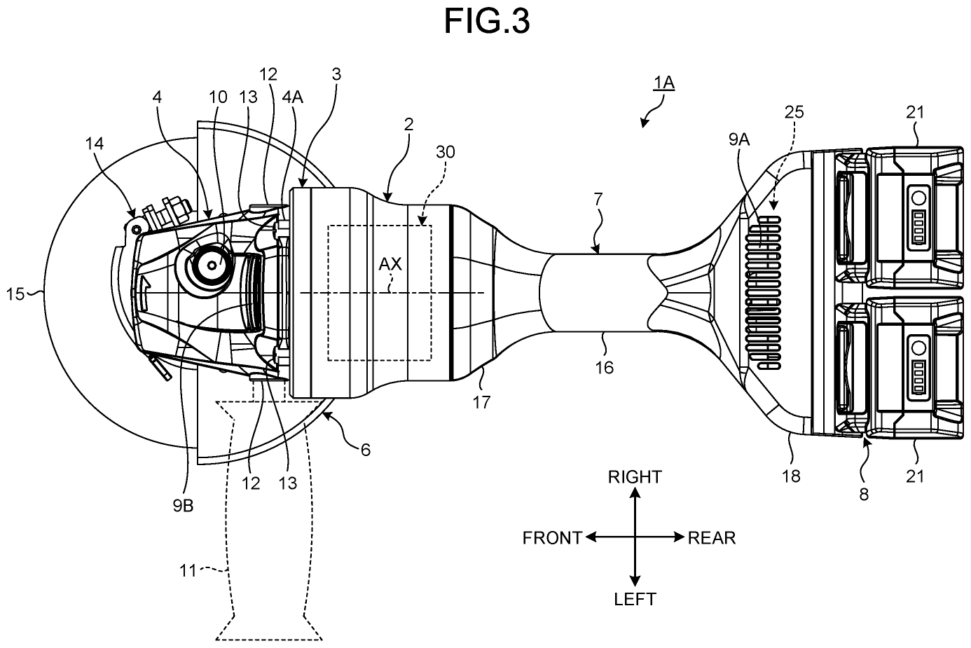

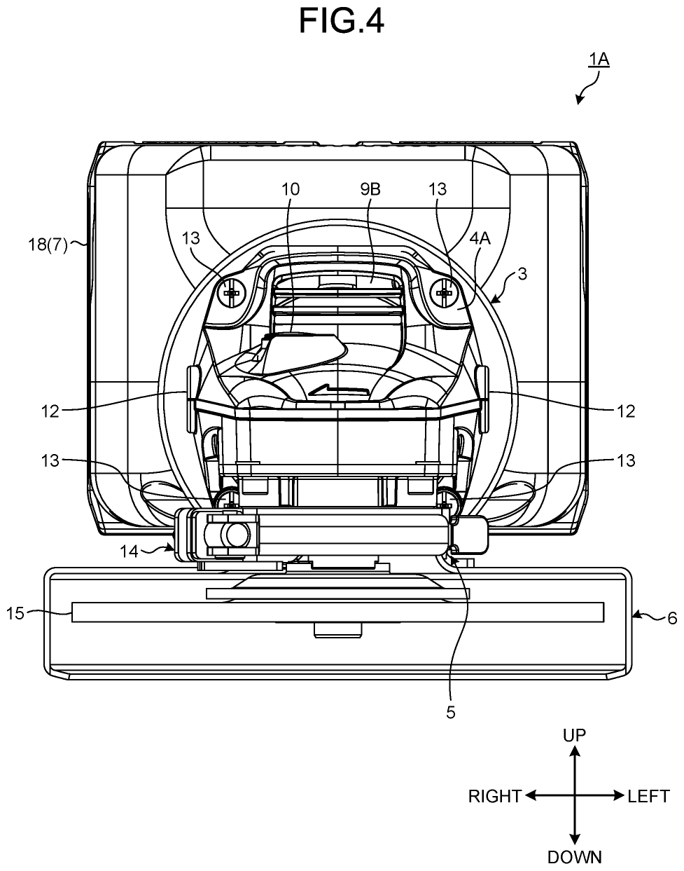

FIG. 1 is an oblique view that shows a power tool 1A according to the present embodiment. FIG. 2 is a side view that shows the power tool 1A according to the present embodiment. FIG. 3 is a plan view that shows the power tool 1A according to the present embodiment. FIG. 4 is a front view that shows the power tool 1A according to the present embodiment.

As shown in FIG. 1, FIG. 2, FIG. 3, and FIG. 4, the power tool 1A comprises: a motor housing 2; a gear-housing cover 3, which is disposed forward of the motor housing 2; a gear housing 4, which is disposed forward of the gear-housing cover 3; a bearing box 5, which is disposed downward of the gear housing 4; a wheel cover 6, which is disposed downward of the bearing box 5; a grip housing 7, which is disposed rearward of the motor housing 2; and battery-mounting parts 8, which are disposed at a rear-end portion of the grip housing 7.

The motor housing 2 houses a motor 30. The motor housing 2 has a tube shape. The motor housing 2 is made of a synthetic resin. In the present embodiment, the motor housing 2 is made of nylon.

The gear-housing cover 3 is disposed between the motor housing 2 and the gear housing 4. The gear-housing cover 3 is mounted on a front portion of the motor housing 2 so as to cover an opening in a front portion of the motor housing 2. The gear-housing cover 3 is made of a metal. In the present embodiment, the gear-housing cover 3 is made of aluminum.

The gear housing 4 houses at least a portion of a spindle 70. In the present embodiment, the gear housing 4 houses an upper portion of the spindle 70. The gear housing 4 is mounted at a front portion of the motor housing 2 with the gear-housing cover 3 interposed therebetween. The gear housing 4 is made of a metal. In the present embodiment, the gear housing 4 is made of aluminum.

A lock switch 10 is provided on the gear housing 4. The lock switch 10 is provided on an upper portion of the gear housing 4. The lock switch 10 is manipulated at the time that rotation of the spindle 70 will be restricted. A user can manipulate the lock switch 10. By manipulating the lock switch 10 such that it moves downward, a lower-end portion of the lock switch 10 is inserted into a hole of a second bevel gear 62, which is described below. By inserting the lower-end portion of the lock switch 10 into the hole of the second bevel gear 62, rotation of the second bevel gear 62 is restricted, and thereby rotation of the spindle 70 is restricted.

As shown in FIG. 3, a side handle 11 is mounted on the gear housing 4. Screw holes 12 are provided in both a left-side surface and a right-side surface of the gear housing 4. The side handle 11 has a threaded portion. By inserting the threaded portion of the side handle 11 into a screw hole 12, and by joining a screw thread of the threaded portion and thread grooves of the screw hole 12, the side handle 11 is mounted on the gear housing 4.

The bearing box 5 holds a bearing 23. The bearing 23 supports the spindle 70 in a rotatable manner. A tool accessory 15 is mounted on a lower-end portion of the spindle 70.

The bearing box 5 retains the wheel cover 6. The wheel cover 6 is fixed to the bearing box 5 by a clamp mechanism 14. The wheel cover 6 is disposed partially around the tool accessory 15. The tool accessory 15 has a disk shape. A grinding wheel is an illustrative example of the tool accessory 15. At least a portion of the wheel cover 6 is disposed rearward of the tool accessory 15.

The grip housing 7 is disposed at a rear portion of the motor housing 2. The grip housing 7 comprises: a grip part 16, which is gripped by the user; a connecting part 17, which is disposed forward of the grip part 16; and a controller-housing part 18, which is disposed rearward of the grip part 16.

The connecting part 17 is connected to the motor housing 2. In the radial direction, the dimension of the connecting part 17 is larger than the dimension of the grip part 16. The controller-housing part 18 houses a controller 25. In the radial direction, the dimension of the controller-housing part 18 is larger than the dimension of the grip part 16.

In the present embodiment, the grip housing 7 comprises an upper housing 7A and a lower housing 7B, which is disposed downward of the upper housing 7A. That is, the grip housing 7 comprises a pair of half housings.

A switch lever 19 is provided on the grip housing 7. The switch lever 19 is provided on a lower portion of the grip housing 7. At the time that the motor 30 will be started, the switch lever 19 is manipulated. The user can manipulate the switch lever 19 in the state in which the user has gripped the grip housing 7. By manipulating the switch lever 19 such that it moves upward, the motor 30 starts.

A lock-OFF lever 20 is provided on the switch lever 19. The lock-OFF lever 20 is provided on an intermediate portion of the switch lever 19 in the front-rear direction. When the switch lever 19 will be set to a manipulatable state or a non-manipulatable state, the lock-OFF lever 20 is manipulated. The user can manipulate the lock-OFF lever 20. By manipulating the lock-OFF lever 20, the switch lever 19 changes from one of the manipulatable state and the non-manipulatable state to the other.

The battery-mounting parts 8 are connected to battery packs 21. The battery-mounting parts 8 are provided at a rear-end portion of the controller-housing part 18. In the present embodiment, two of the battery-mounting parts 8 are provided in a left-right direction. The battery packs 21 are mounted on the battery-mounting parts 8. The battery packs 21 are mountable on the battery-mounting parts 8 in a detachable manner. The battery packs 21 comprise secondary batteries. In the present embodiment, the battery packs 21 comprise rechargeable lithium-ion batteries. By being mounted on the battery-mounting parts 8, the battery packs 21 can supply electric power to the power tool 1A. The motor 30 is driven using electric power supplied from the battery packs 21.

The grip housing 7 has air-suction ports 9A. The air-suction ports 9A are provided in an upper portion of the controller-housing part 18. Air flows from the exterior space of the grip housing 7 into the interior space of the grip housing 7 via the air-suction ports 9A.

The gear housing 4 comprises a plate part 4A, which is connected to the gear-housing cover 3. In addition, the gear housing 4 has air-exhaust ports 9B. The air-exhaust ports 9B are provided in an upper portion of the plate part 4A such that they face forward. Air flows out of the interior space of the gear housing 4 to the exterior space of the gear housing 4 via the air-exhaust ports 9B.

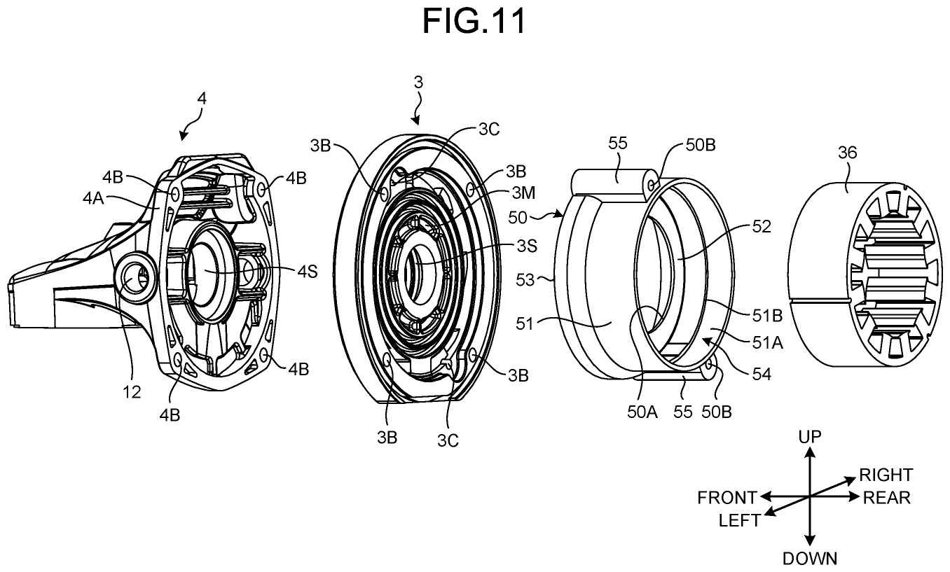

The interior space of the grip housing 7 and the interior space of the motor housing 2 are connected via vents. The interior space of the motor housing 2 and the interior space of the gear housing 4 are connected via vents 3M (refer to FIG. 11), which are provided in the gear-housing cover 3. Air that has flowed into the interior space of the grip housing 7 via the air-suction ports 9A circulates through the interior space of the grip housing 7, the interior space of the motor housing 2, and the interior space of the gear housing 4, after which it flows out to the exterior space of the gear housing 4 via the air-exhaust ports 9B.

<Internal Structure of Power Tool>

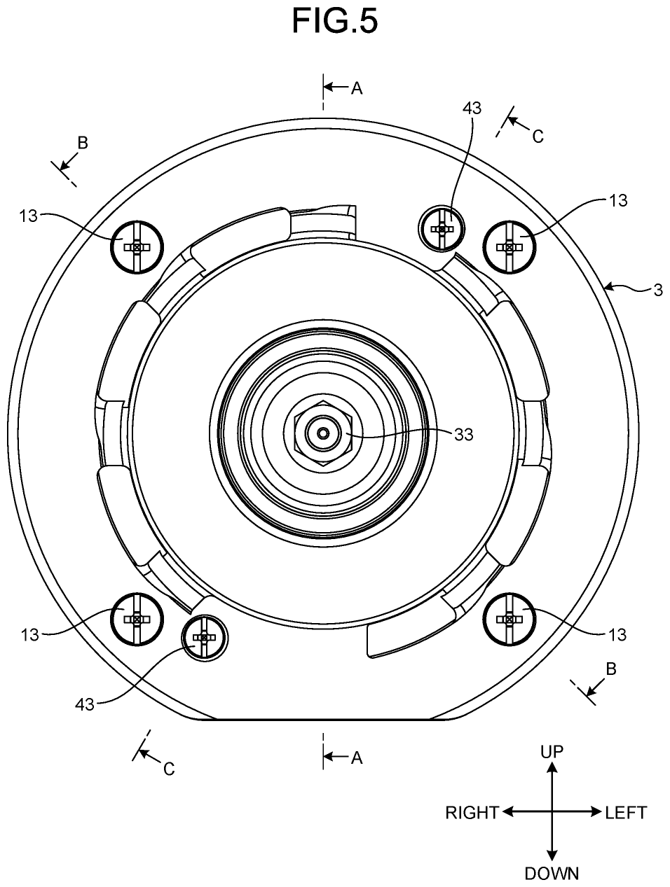

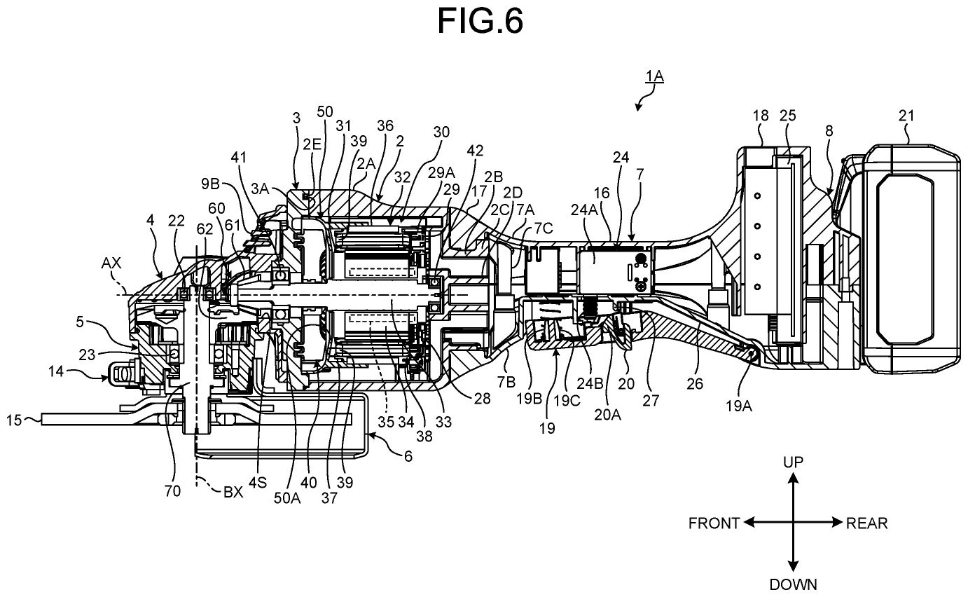

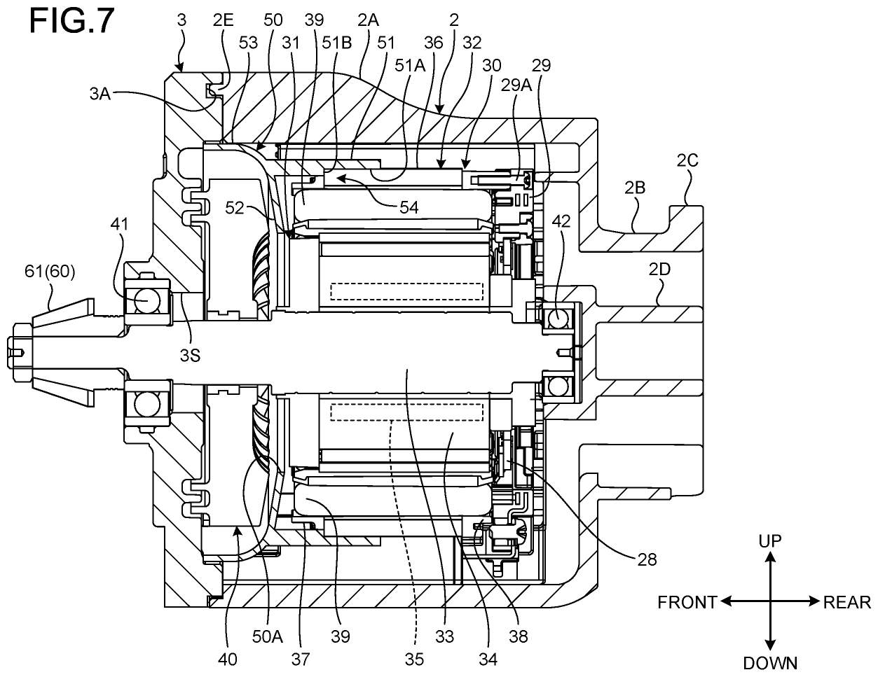

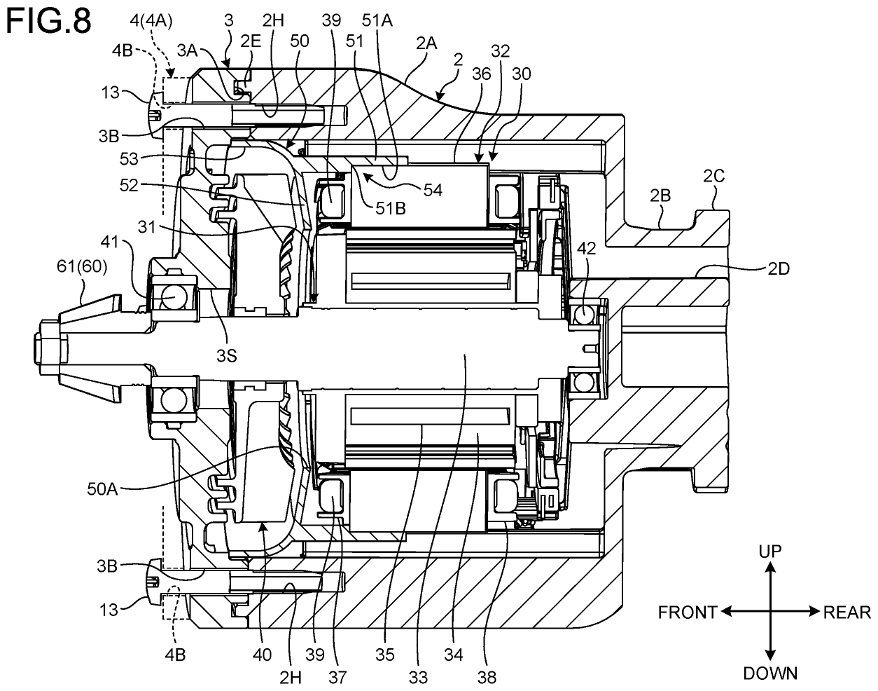

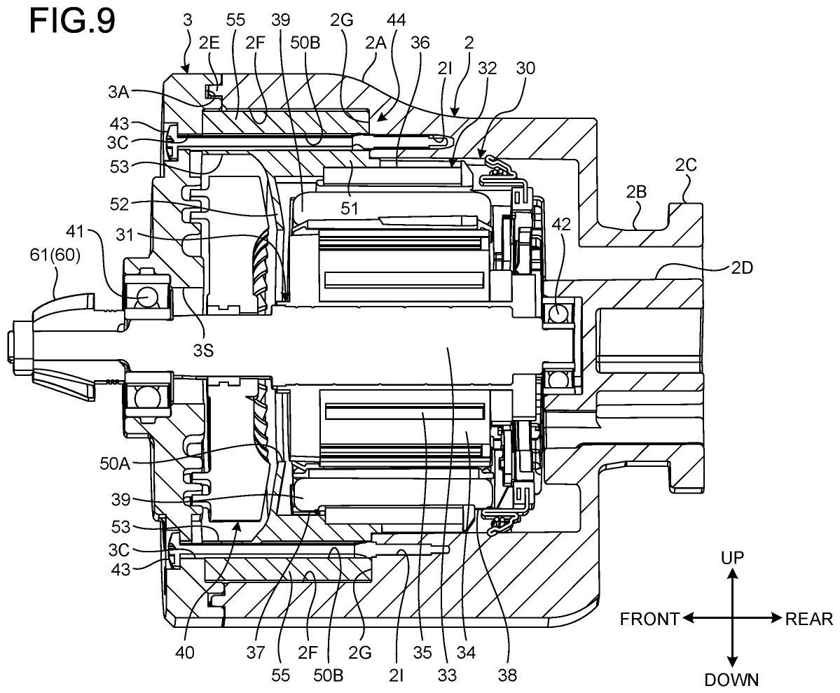

FIG. 5 is a partial front view of the power tool 1A according to the present embodiment. FIG. 5 corresponds to a view in which the gear-housing cover 3 is viewed from the front. In FIG. 5, the illustration of the gear housing 4 is omitted. FIG. 6 is a cross-sectional view that shows the power tool 1A according to the present embodiment. FIG. 7 is a partial, enlarged, cross-sectional view of the power tool 1A according to the present embodiment and corresponds to a cross-sectional auxiliary view taken along line A-A in FIG. 5. FIG. 8 and FIG. 9 are both partial, enlarged, cross-sectional views of the power tool 1A according to the present embodiment. FIG. 8 corresponds to a cross-sectional auxiliary view taken along line B-B in FIG. 5. FIG. 9 corresponds to a cross-sectional auxiliary view taken along line C-C in FIG. 5.

As shown in FIG. 1, FIG. 2, FIG. 3, FIG. 4, FIG. 5, and FIG. 8, the gear housing 4, the gear-housing cover 3, and the motor housing 2 are fixed by screws 13.

The gear housing 4 comprises the plate part 4A, which is connected to the gear-housing cover 3. In the present embodiment, the screws 13 are installed at four locations of an outer-edge portion of the plate part 4A. The plate part 4A of the gear housing 4, the gear-housing cover 3, and the motor housing 2 are fixed to one another by the four screws 13.

As shown in FIG. 6 and FIG. 7, the power tool 1A comprises the motor housing 2, the gear-housing cover 3, the gear housing 4, the bearing box 5, the wheel cover 6, the grip housing 7, the battery-mounting parts 8, the motor 30, a centrifugal fan 40, a bearing 41, a bearing 42, a baffle 50, a power-transmission mechanism 60, and the spindle 70.

The motor housing 2 houses the motor 30, the centrifugal fan 40, and the baffle 50. The motor housing 2 comprises: a housing part 2A, which is disposed around the motor 30 and the baffle 50; an outer-tube part 2B, which protrudes rearward from the rear portion of the housing part 2A; a stop part 2C, which is disposed at a rear portion of the outer-tube part 2B; and an inner-tube part 2D, which is disposed inward of the outer-tube part 2B. The housing part 2A has a tube shape. In the radial direction, the dimension of the housing part 2A is larger than the dimension of the outer-tube part 2B. The stop part 2C protrudes outward in the radial direction from a rear portion of the outer-tube part 2B. In addition, the motor housing 2 comprises a protruding part 2E, which is provided on a front-end surface of the housing part 2A. The protruding part 2E protrudes forward from the front-end surface of the housing part 2A.

The gear-housing cover 3 is disposed between the motor housing 2 and the gear housing 4. The gear-housing cover 3 has a plate shape. The gear-housing cover 3 is mounted on a front portion of the motor housing 2 so as to cover the opening in the front portion of the motor housing 2. In addition, the gear-housing cover 3 has a recessed part 3A. The recessed part 3A is provided on a rear surface of the gear-housing cover 3. In the state in which the gear-housing cover 3 is mounted on the motor housing 2, the protruding part 2E is disposed inward of the recessed part 3A.

The gear housing 4 houses the power-transmission mechanism 60. The gear housing 4 holds a bearing 22. The bearing 22 supports the spindle 70 in a rotatable manner.

The bearing box 5 holds the bearing 23. The bearing 23 supports the spindle 70 in a rotatable manner.

The spindle 70 is housed in both the gear housing 4 and the bearing box 5. The gear housing 4 houses an upper portion of the spindle 70. The bearing box 5 houses a lower portion of the spindle 70.

The grip housing 7 is mounted at a rear portion of the motor housing 2. The connecting part 17 of the grip housing 7 is disposed around the outer-tube part 2B and the stop part 2C. The upper housing 7A and the lower housing 7B are disposed such that they sandwich the outer-tube part 2B and the stop part 2C. The upper housing 7A and the lower housing 7B are fixed by a screw, which is disposed in a screw boss 7C. By hooking the connecting part 17 on the stop part 2C, the connecting part 17 and the stop part 2C are engaged. Owing to the engagement of the connecting part 17 and the stop part 2C, the motor housing 2 and the grip housing 7 are sufficiently fixed to one another.

The grip housing 7 houses a switch apparatus 24 and the controller 25. The switch apparatus 24 is housed in the grip part 16. The controller 25 is housed in the controller-housing part 18.

The switch apparatus 24 comprises: a switch circuit; a casing 24A, which houses the switch circuit; and a plunger 24B, which protrudes downward from the casing 24A.

The switch lever 19 is disposed in a recessed part 26, which is provided in a lower portion of the lower housing 7B. The switch lever 19 is capable of contacting the plunger 24B. A rear portion of the switch lever 19 is supported, via a hinge 19A, by the lower housing 7B in a pivotable manner. In addition, the switch lever 19 comprises a projection part 19C, which holds a spring 19B. The projection part 19C is provided on a front portion of the switch lever 19. The spring 19B generates an elastic force, which causes the switch lever 19 to move downward.

By manipulating the switch lever 19 to move upward, the plunger 24B moves upward. By virtue of the plunger 24B moving upward, the switch apparatus 24 operates so as to start the motor 30. When the manipulation of the switch lever 19 is released, the switch lever 19 moves downward owing to the elastic force of the spring 19B. When the switch lever 19 moves downward, the plunger 24B moves downward. Owing to the plunger 24B moving downward, the switch apparatus 24 operates so that the motor 30 stops.

The lock-OFF lever 20 changes the switch lever 19 from one of the manipulatable state and the non-manipulatable state to the other. The lock-OFF lever 20 is supported by the switch lever 19 in a pivotable manner. A projection part 27 is provided inward of the recessed part 26. The projection part 27 protrudes downward from an inner surface of the recessed part 26. The lock-OFF lever 20 comprises a protruding part 20A. By virtue of the lock-OFF lever 20 being pivoted in one direction and the protruding part 20A being hooked on the projection part 27, the protruding part 20A and the projection part 27 engage. Owing to the engagement of the protruding part 20A and the projection part 27, the switch lever 19 is fixed in the state in which it is disposed downward. In the state in which the protruding part 20A and the projection part 27 are engaged, the user cannot manipulate the switch lever 19 and therefore cannot start the motor 30. By pivoting the lock-OFF lever 20 in a reverse direction and releasing the engagement of the protruding part 20A and the projection part 27, the switch lever 19 is capable of moving upward. In the state in which the engagement of the protruding part 20A and the projection part 27 is released, the user can manipulate the switch lever 19 and therefore can start the motor 30.

The controller 25 outputs control signals, which control the motor 30. The controller 25 comprises a circuit board, which comprises a plurality of electronic components.

The motor 30 is the motive power source of the power tool 1A. The motor 30 is an inner-rotor type brushless motor. The motor 30 comprises a rotor 31 and a stator 32, which is disposed around the rotor 31.

The rotor 31 rotates about the rotational axis AX. The rotor 31 comprises: a rotary shaft 33; a rotor core 34, which is disposed around the rotary shaft 33; and a plurality of permanent magnets 35 disposed in the interior of the rotor core 34. The rotary shaft 33 extends in the axial direction. The rotor core 34 has a circular-cylinder shape. The rotor core 34 comprises a plurality of stacked steel sheets. The permanent magnets 35 are disposed spaced apart around the rotary shaft 33.

The stator 32 comprises: a stator core 36, which has a tube shape; a front insulator 37, which is provided on a front-end surface of the stator core 36; a rear insulator 38, which is provided on a rear-end surface of the stator core 36; and coils 39, which are mounted on the stator core 36 via the front insulator 37 and the rear insulator 38. The stator core 36 comprises a plurality of stacked steel sheets.

A sensor circuit board 28 and a short-circuiting member 29 are mounted on the rear insulator 38. The sensor circuit board 28 and the short-circuiting member 29 are fixed to the rear insulator 38 by screws 29A. The sensor circuit board 28 comprises a circuit board, which has a circular-ring shape, and rotation-detection devices, which are installed on the circuit board. The rotation-detection devices detect the location of the rotor 31 in the rotational direction by detecting the locations of the permanent magnets 35 of the rotor 31. The short-circuiting member 29 comprises wiring the connects the plurality of coils 39.

The centrifugal fan 40 rotates owing to the rotation of the rotor 31. The centrifugal fan 40 is mounted on a front portion of the rotary shaft 33. By rotating the rotary shaft 33, the centrifugal fan 40 rotates together with the rotary shaft 33. The centrifugal fan 40 is disposed forward of the motor 30.

By rotating the centrifugal fan 40, air flows from the exterior space of the grip housing 7 into the interior space of the grip housing 7 via the air-suction ports 9A. The air that has flowed into the interior space of the grip housing 7 circulates through the interior space of the grip housing 7, and thereby cools the controller 25. The air that has circulated through the interior space of the grip housing 7 flows into the interior space of the motor housing 2. The air that has flowed into the interior space of the motor housing 2 circulates through the interior space of the motor housing 2, and thereby cools the motor 30. The air that has circulated through the interior space of the motor housing 2 flows into the gear housing 4 via the vents 3M of the gear-housing cover 3. The air that has flowed into the gear housing 4 circulates through the interior space of the gear housing 4, after which it flows out to the exterior space of the gear housing 4 via the air-exhaust ports 9B.

The bearing 41 and the bearing 42 both support the rotary shaft 33 of the rotor 31 in a rotatable manner. The bearing 41 supports a front portion of the rotary shaft 33 in a rotatable manner. The bearing 42 supports a rear portion of the rotary shaft 33 in a rotatable manner. The bearing 41 is held by the gear-housing cover 3. The bearing 41 is disposed in an opening 3S, which is provided in a center portion of the gear-housing cover 3. The bearing 42 is held by the inner-tube part 2D of the motor housing 2.

The baffle 50 guides air that is circulated by the centrifugal fan 40. At least a portion of the baffle 50 is disposed around the centrifugal fan 40. At least a portion of the baffle 50 is disposed between the centrifugal fan 40 and the stator 32.

The baffle 50 has an opening 50A, in which the rotary shaft 33 is disposed. The air that has flowed in via the air-suction ports 9A and circulated through the motor 30 flows into the centrifugal fan 40 via the opening 50A. The air that has flowed into the centrifugal fan 40 flows outward in the radial direction from the centrifugal fan 40. The baffle 50 guides the air from the centrifugal fan 40 forward. The gear-housing cover 3 is disposed forward of the centrifugal fan 40. The gear-housing cover 3 has the vents 3M (refer to FIG. 11), through which air can circulate. The air that has been guided forward of the centrifugal fan 40 by the baffle 50 circulates through the vents 3M of the gear-housing cover 3 and circulates through the interior space of the gear housing 4, after which it flows out via the air-exhaust port 9B.

In the present embodiment, the baffle 50 holds the stator 32. The baffle 50 is supported by the gear-housing cover 3. At least a portion of the baffle 50 is disposed around the stator core 36. The stator core 36 is held by the baffle 50.

The baffle 50 is made of a metal. In the present embodiment, the baffle 50 is made of aluminum.

The power-transmission mechanism 60 transmits, to the spindle 70, motive power generated by the motor 30. A front-end portion of the rotary shaft 33, which is forward of the bearing 41, is disposed in the interior space of the gear housing 4. The power-transmission mechanism 60 comprises: a first bevel gear 61, which is provided on a front-end portion of the rotary shaft 33; and the second bevel gear 62, which is provided on an upper-end portion of the spindle 70. The first bevel gear 61 and the second bevel gear 62 mesh with one another. The spindle 70 rotates owing to the rotation of the rotor 31. When the rotary shaft 33 of the rotor 31 rotates about the rotational axis AX, the first bevel gear 61 rotates. When the first bevel gear 61 rotates, the second bevel gear 62 rotates. When the second bevel gear 62 rotates, the spindle 70 rotates about the rotational axis BX.

By manipulating the lock switch 10, at least a portion of the lock switch 10 engages with the second bevel gear 62. As described above, by manipulating the lock switch 10, a lower-end portion of the lock switch 10 is inserted into the hole of the second bevel gear 62. Owing to the engagement of the lock switch 10 and the second bevel gear 62, the rotation of the spindle 70 is restricted.

The spindle 70 is supported by the bearing 22 and the bearing 23 in a rotatable manner. The bearing 22 supports the upper portion of the spindle 70 in a rotatable manner. The bearing 23 supports an intermediate portion and a lower portion of the spindle 70 in a rotatable manner. The bearing 22 is held by the gear housing 4. The bearing 23 is held by the bearing box 5.

The tool accessory 15 is mounted on a lower-end portion of the spindle 70. Owing to the spindle 70 rotating, the tool accessory 15 rotates about the rotational axis BX.

<Gear-Housing Cover and Baffle>

As shown in FIG. 7, FIG. 8, and FIG. 9, the baffle 50 is disposed inward of the motor housing 2. The baffle 50 holds the stator 32.

The gear-housing cover 3 is fixed to both the gear housing 4 and the motor housing 2. As shown in FIG. 8, the gear housing 4, the gear-housing cover 3, and the motor housing 2 are fixed by the screws 13.

The baffle 50 is supported by both the gear-housing cover 3 and the motor housing 2. The gear-housing cover 3 is supported by the baffle 50 in an immovable manner at least in the radial direction. That is, the relative position between the gear-housing cover 3 and the baffle 50 in the radial direction does not change. In the present embodiment, the gear-housing cover 3 is supported by the baffle 50 in an immovable manner not only in the radial direction but also in the axial direction and in the circumferential direction. That is, the relative position between the gear-housing cover 3 and the baffle 50 in the axial direction does not change. The relative position between the gear-housing cover 3 and the baffle 50 in the circumferential direction does not change. As shown in FIG. 9, in the present embodiment, the gear-housing cover 3, the baffle 50, and the motor housing 2 are fixed by screws 43.

In this manner, in the present embodiment, the gear-housing cover 3, which holds the bearing 41 and is made of a metal, is fixed to both the motor housing 2, which is made of a synthetic resin, and the baffle 50, which is made of a metal.

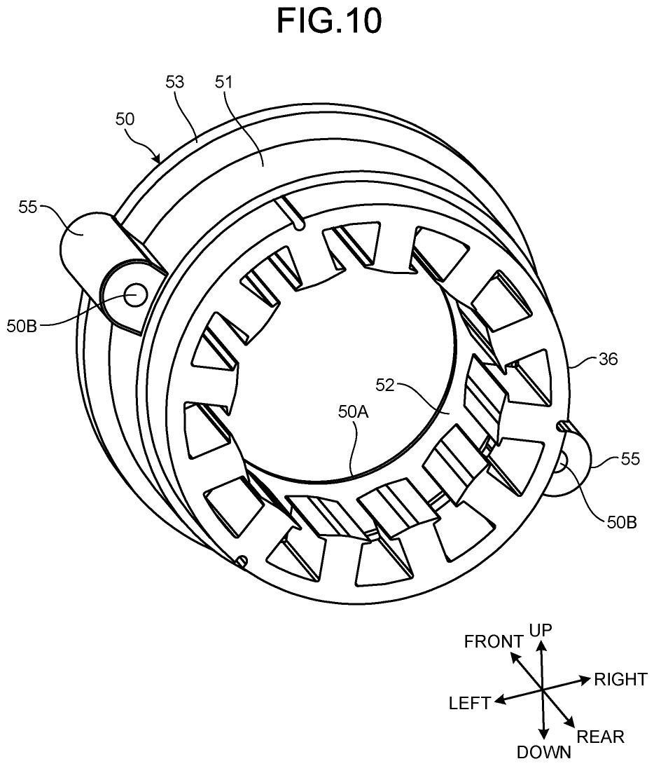

FIG. 10 is an oblique view that shows the baffle 50 and the stator core 36 according to the present embodiment. FIG. 11 is an exploded, oblique view that shows the gear housing 4, the gear-housing cover 3, the baffle 50, and the stator core 36 according to the present embodiment.

As shown in FIG. 6 and FIG. 11, an opening 4S, in which the rotary shaft 33 is disposed, is provided in a center portion of the gear housing 4. In addition, as shown in FIG. 11, the gear-housing cover 3 has the vents 3M, through which air can circulate.

As shown in FIG. 7, FIG. 8, FIG. 9, FIG. 10, and FIG. 11, the baffle 50 holds the stator 32.

The baffle 50 comprises: a tube part 51, which contacts the stator 32; an opposing part 52, which opposes an end surface of the stator 32 in the axial direction; and a circumferential-wall part 53, which is disposed around the centrifugal fan 40.

The tube part 51 makes contact with an outer-circumferential surface of the stator 32. The outer-circumferential surface of the stator 32 includes the outer-circumferential surface of the stator core 36. In addition, the tube part 51 makes contact with a front-end surface of the stator core 36.

The opposing part 52 opposes the front-end surface of the stator 32, with a gap interposed therebetween. The front-end surface of the stator 32 includes a front-end surface of the front insulator 37 and front-end surfaces of the coils 39. In the axial direction, the opposing part 52 is disposed between the stator 32 and the centrifugal fan 40.

The circumferential-wall part 53 is disposed around the centrifugal fan 40. The front-end surface of the circumferential-wall part 53 makes contact with the gear-housing cover 3. An inner-circumferential surface of the circumferential-wall part 53 and a front surface of the opposing part 52 are connected via a curved surface.

The baffle 50 comprises a positioning part 54, which positions the stator 32. The positioning part 54 positions the stator 32 in the radial direction, the axial direction, and the circumferential direction. In the present embodiment, the positioning part 54 is provided on the tube part 51. The positioning part 54 comprises: an inner-circumferential surface 51A of the tube part 51, which makes contact with the outer-circumferential surface of the stator core 36; and a support surface 51B of the tube part 51, which makes contact with the front-end surface of the stator core 36. The support surface 51B faces rearward. The stator 32 is positioned in the radial direction by the inner-circumferential surface 51A. The stator 32 is positioned in the axial direction by the support surface 51B. By fitting the stator core 36 in the interior of the tube part 51, the stator 32 is positioned in the circumferential direction.

In addition, the baffle 50 comprises protruding parts 55, which protrude outward in the radial direction from an outer-circumferential surface of the tube part 51 and an outer-circumferential surface of the circumferential-wall part 53. In the present embodiment, two of the protruding parts 55 are provided.

As shown in FIG. 9, the motor housing 2 comprises a positioning part 44, which positions the baffle 50. The positioning part 44 positions the baffle 50 in the radial direction, the axial direction, and the circumferential direction. In the present embodiment, the positioning part 44 is provided on the motor housing 2 and comprises recessed parts, in which the protruding parts 55 are disposed. The positioning part 44 has: inner surfaces 2F of the recessed parts, which make contact with outer surfaces of the protruding parts 55; and support surfaces 2G of the recessed parts, which make contact with rear-end surfaces of the protruding parts 55. The support surfaces 2G face forward. The baffle 50 is positioned in the radial direction and the circumferential direction by the inner surfaces 2F. The baffle 50 is positioned in the axial direction by the support surfaces 2G.

As shown in FIG. 8 and FIG. 11, the gear housing 4 comprises the plate part 4A, which is connected to the gear-housing cover 3. Openings 4B, in which the screws 13 are disposed, are provided in an outer-edge portion of the plate part 4A. In addition, openings 3B, in which the screws 13 are disposed, are provided in an outer-edge portion of the gear-housing cover 3. As shown in FIG. 8, the motor housing 2 has screw holes 2H, in which the screws 13 are joined. The screw holes 2H are provided in a front-end surface of the motor housing 2. The front-end surface of the motor housing 2 and a circumferential-edge area of a rear surface of the gear-housing cover 3 contact one another. In the state in which the gear-housing cover 3 is disposed between the plate part 4A of the gear housing 4 and the motor housing 2, the screws 13 are disposed in the openings 4B and the openings 3B and are joined in the screw holes 2H, and thereby the gear housing 4, the gear-housing cover 3, and the motor housing 2 are fixed to one another.

As shown in FIG. 9 and FIG. 11, openings 3C, in which the screws 43 are disposed, are provided in an outer-edge portion of the gear-housing cover 3. In addition, openings 50B, in which the screws 43 are disposed, are provided in the baffle 50. The openings 50B are provided in the protruding parts 55. As shown in FIG. 9, the motor housing 2 has screw holes 2I, in which the screws 43 are joined. The screw holes 2I are provided in the support surfaces 2G in the interior of the motor housing 2. The support surfaces 2G of the motor housing 2 and the rear-end surfaces of the protruding parts 55 contact one another. In the state in which the baffle 50 is disposed in the interior of the motor housing 2 and the openings in the front portion of the motor housing 2 are covered by the gear-housing cover 3, the screws 43 are disposed in the openings 3C and the openings 50B and joined in the screw holes 2I, and thereby the gear-housing cover 3, the baffle 50, and the motor housing 2 are fixed to one another.

In the state in which the screws 43 are joined tin the screw holes 2I, head parts of the screws 43 are disposed rearward of the front surface of the gear-housing cover 3. That is, the head parts of the screws 43 do not protrude forward from the front surface of the gear-housing cover 3. Thereby, the plate part 4A of the gear housing 4 and the front surface of the gear-housing cover 3 can contact one another.

<Operation>

Next, the operation of the power tool 1A according to the present embodiment will be explained. The user manipulates the lock-OFF lever 20 to set the switch lever 19 to the manipulatable state. By manipulating the switch lever 19, the controller 25 supplies electric current from the battery packs 21 to the motor 30. When electric current is supplied to the motor 30 and the motor 30 starts, the rotor 31 rotates. Owing to the rotation of the rotor 31, the spindle 70 rotates. Owing to the rotation of the spindle 70, the tool accessory 15, which is mounted at a lower-end portion of the spindle 70, rotates. Thereby, the user can perform work in which the power tool 1A is used.

In addition, owing to the rotation of the rotor 31, the centrifugal fan 40 rotates. Owing to the rotation of the centrifugal fan 40, air flows from the exterior space of the grip housing 7 into the interior space of the grip housing 7 via the air-suction ports 9A. The air that has flowed into the interior space of the grip housing 7 makes contact with the controller 25. Thereby, the controller 25 is cooled. The air that has flowed into the interior space of the grip housing 7 circulates forward through the interior space of the grip housing 7, after which it flows into the interior space of the motor housing 2. The air that has flowed into the interior space of the motor housing 2 circulates forward in the interior space of the motor housing 2 between the stator 32 and the rotor 31. Thereby, the motor 30 is cooled. The air that has circulated through the space between the stator 32 and the rotor 31 flows into the centrifugal fan 40 via the opening 50A of the baffle 50. The air that has flowed into the centrifugal fan 40 flows outward in the radial direction from the centrifugal fan 40. The baffle 50 guides forward the air that has flowed out from the centrifugal fan 40. The air that was guided by the baffle 50 passes through the vents 3M of the gear-housing cover 3 and circulates through the interior space of the gear housing 4, after which it flows out to the exterior space of the gear housing 4 via the air-exhaust ports 9B.

In the present embodiment, the baffle 50 functions as a stator-holding member that holds the stator 32 and is made of a metal. In addition, the gear-housing cover 3 functions as a bearing-retaining member that retains the bearing 41, which supports the rotor 31 in a rotatable manner, and is made of a metal. The gear-housing cover 3 is supported by the baffle 50 in an immovable manner in the radial direction. The stator 32 is held by the baffle 50. The rotor 31 is supported by the gear-housing cover 3 via the bearing 41. By fixing the baffle 50 and the gear-housing cover 3 such that the relative position between the gear-housing cover 3 and the baffle 50 in the radial direction is maintained, changes in the relative position between the central axis of the stator 32 and the rotational axis AX of the rotor 31 are curtailed. That is, the state in which the central axis of the stator 32 and the rotational axis AX of the rotor 31 coincide is maintained, and thereby tilting of the rotor 31 relative to the stator 32 is curtailed. Consequently, a gap between the rotor 31 and the stator 32 is maintained, and thereby contact between the rotor 31 and the stator 32 is curtailed.

For example, in the situation in which the stator were to be held by a stator-holding member, which is made of a synthetic resin, and the stator-holding member is supported by the bearing-retaining member, there is a possibility that the stator-holding member will deform owing to a change in the environment (humidity or temperature) in which the power tool is used. That is, there is a possibility that the stator-holding member, which is made of a synthetic resin, will deform owing to moisture absorption and heat. If the stator-holding member deforms, then there is a strong possibility that the bearing-retaining member will move in the radial direction, will tilt, or the like. If the bearing-retaining member moves in the radial direction, tilts, or the like, then the bearings that support the rotor will tilt. If the bearings tilt, then the rotor 31 will tilt relative to the stator 32.

In the present embodiment, the stator 32 is held by the baffle 50, which is made of a metal, in an immovable manner in the radial direction. Even if the environment in which the power tool 1A is used changes, the baffle 50, which is made of a metal, does not deform. Because the baffle 50 does not deform, movement of the gear-housing cover 3 in the radial direction, tilting of the gear-housing cover 3, or the like is curtailed. Because movement of the gear-housing cover 3 in the radial direction, tilting of the gear-housing cover 3, or the like is curtailed, tilting of the bearing 41, which supports the rotor 31, is curtailed. Consequently, tilting of the rotor 31 relative to the stator 32 is curtailed.

<Effects>

According to the present embodiment as explained above, the power tool 1A comprises: the baffle 50, which holds the stator 32 and is made of a metal; the bearing 41, which supports the rotor 31 in a rotatable manner; and the gear-housing cover 3, which is supported by the baffle 50 in an immovable manner in the radial direction, holds the bearing 41, and is made of a metal. Thereby, even if the environment (humidity or temperature) in which the power tool 1A is used changes, deformation of the baffle 50 due to moisture absorption or heat is curtailed. In addition, because the gear-housing cover 3 is also made of a metal, deformation of the gear-housing cover 3 due to moisture absorption or heat is curtailed. In addition, the baffle 50, which holds the stator 32, and the gear-housing cover 3, which supports the rotor 31 via the bearing 41, are fixed by the screws 43. Thereby, even if the environment in which the power tool 1A is used changes, tilting of the rotor 31 relative to the stator 32 is curtailed. Consequently, a gap between the rotor 31 and the stator 32 is maintained, and thereby contact between the rotor 31 and the stator 32 is curtailed.

In addition, owing to the stator 32 being held by the baffle 50, which is made of a metal, the resonance frequency of the vibration system that includes the stator 32 and the baffle 50 is adjusted. When the motor 30 is operating, the generation of noise is curtailed by tuning the resonance frequency such that resonance of the stator 32 is curtailed. In addition, the resonance of the stator 32 is curtailed by tuning at least one of the material, the stiffness, the weight, and the shape of the baffle 50 based on the resonance frequency of the stator 32.

In addition, because the baffle 50, which makes contact with the stator 32, is made of a metal, a rise in the temperature of the motor 30 during the operation of the motor 30 is curtailed owing to the heat-dissipating effect of the baffle 50.

The baffle 50 comprises the positioning part 54, which positions the stator 32. Thereby, changes in the relative position between the baffle 50 and the stator 32 are curtailed.

The baffle 50 comprises the tube part 51, which contacts the stator 32, and the opposing part 52, which opposes the end surface of the stator 32 in the axial direction. In the present embodiment, the opposing part 52 is disposed between the stator 32 and the centrifugal fan 40 in the axial direction. Thereby, the baffle 50 can sufficiently hold the stator 32 owing to the tube part 51. In addition, the baffle 50 can guide the air owing to the opposing part 52.

In the present embodiment, the motor housing 2 is made of a synthetic resin. Thereby, lightweightness of the power tool 1A is achieved and cost is curtailed. In the situation in which the motor housing 2 is made of a synthetic resin, there is a possibility that the motor housing 2 will deform owing to a change in the environment (humidity or temperature) in which the power tool 1A is used; nevertheless, because the gear-housing cover 3 and the baffle 50 are fixed such that the relative position between the gear-housing cover 3 and the baffle 50 in the radial direction is maintained, tilting of the rotor 31 relative to the stator 32 is curtailed.

### Modified Examples

In the embodiment described above, it was assumed that the gear-housing cover 3 is supported by the baffle 50 in an immovable manner in the radial direction, the axial direction, and the circumferential direction. The gear-housing cover 3 may be supported by the baffle 50 in an immovable manner in the radial direction and supported in the baffle 50 in a movable manner in at least one of the axial direction and the circumferential direction.

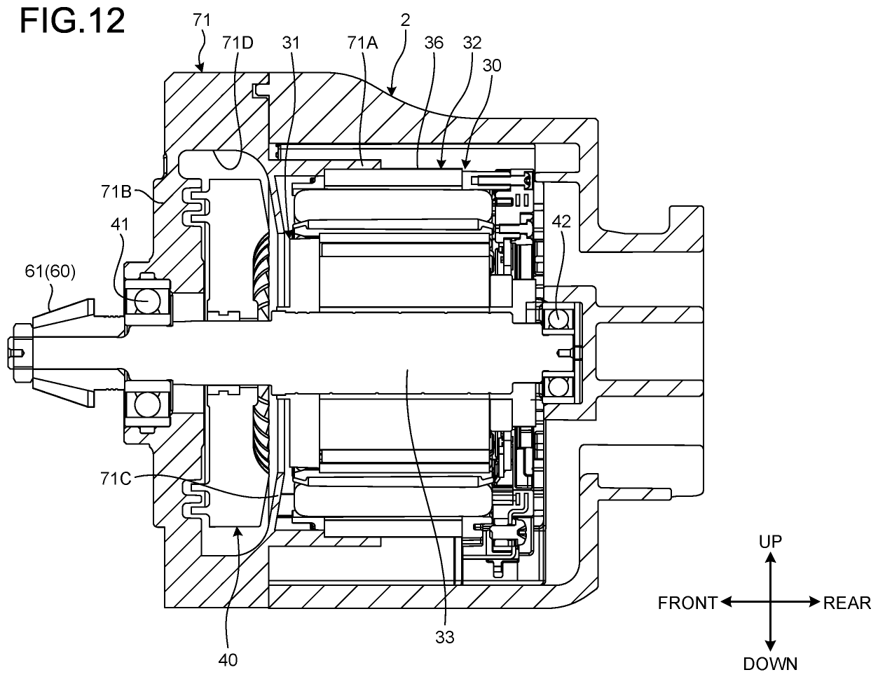

FIG. 12 is a drawing that shows a modified example of the power tool 1A according to the present embodiment. In the embodiment described above, it was assumed that the gear-housing cover 3 and the baffle 50 are separate bodies and that the gear-housing cover 3 and the baffle 50 are fixed by the screws 43. As shown in FIG. 12, the baffle 50 and the gear-housing cover 3 may be integral. That is, a single holding member 71 may be provided that has the functions of the stator-holding member (the baffle 50) and the bearing-retaining member (the gear-housing cover 3). In FIG. 12, the holding member 71 is made of a metal such as aluminum. The holding member 71 comprises a stator-holding part 71A, which holds the stator 32, and a bearing-retaining part 71B, which retains the bearing 41. In addition, the holding member 71 comprises an opposing part 71C, which opposes the front-end surface of the stator 32, and a circumferential-wall part 71D, which is disposed around the centrifugal fan 40. The stator-holding part 71A has a tube shape. The bearing-retaining part 71B is a plate shape. The bearing-retaining part 71B is disposed forward of the stator-holding part 71A. The gear housing 4 is fixed to the bearing-retaining part 71B by screws. The holding member 71 is fixed to the motor housing 2.

The holding member 71 may comprise a left housing and a right housing, which is disposed rightward of the left housing. That is, the holding member 71 may comprise a pair of half members. The pair of half members may be fixed by screws.

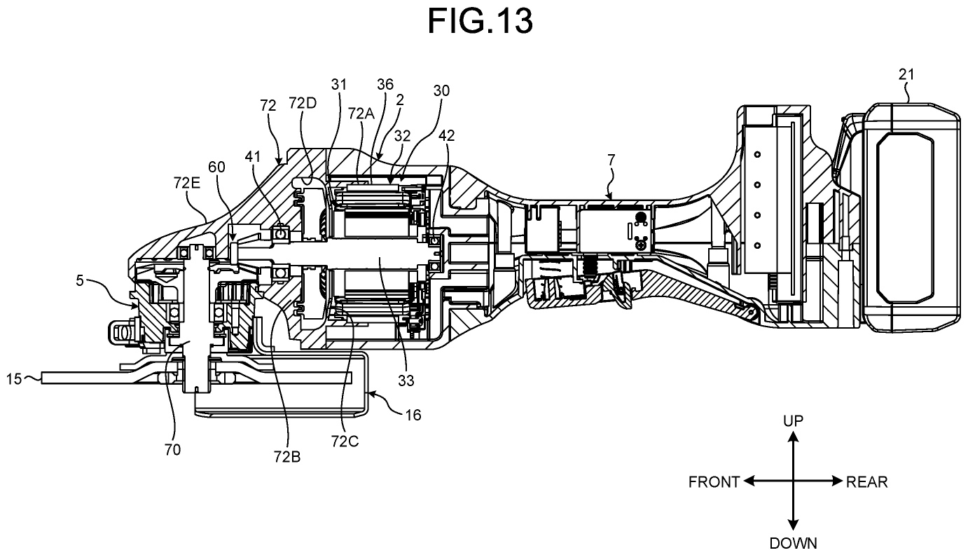

FIG. 13 is a drawing that shows a modified example of the power tool 1A according to the present embodiment. As shown in FIG. 13, the baffle 50, the gear-housing cover 3, and the gear housing 4 may be integral. That is, a single holding member 72 may be provided that has the functions of the stator-holding member (the baffle 50), the bearing-retaining member (the gear-housing cover 3), and the gear housing 4. In FIG. 13, the holding member 72 is made of a metal such as aluminum. The holding member 72 comprises: a stator-holding part 72A, which holds the stator 32; a bearing-retaining part 72B, which retains the bearing 41; an opposing part 72C, which opposes the front-end surface of the stator 32; and a circumferential-wall part 72D, which is disposed around the centrifugal fan 40. In addition, the holding member 72 has a housing part 72E, which houses the power-transmission mechanism 60 and the spindle 70. The holding member 72 is fixed to the motor housing 2.

The holding member 72 may comprise a left housing and a right housing, which is disposed rightward of the left housing. That is, the holding member 72 may comprise a pair of half members. The pair of half members may be fixed by screws.

### Second Embodiment

A second embodiment will now be explained. In the explanation below, structural elements that are identical or equivalent to those in the embodiment described above are assigned identical symbols, and explanations thereof are abbreviated or omitted.

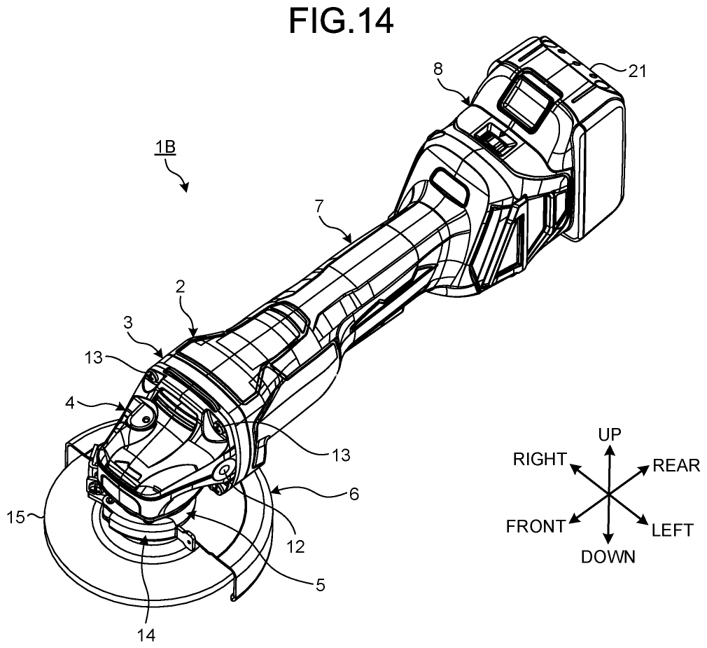

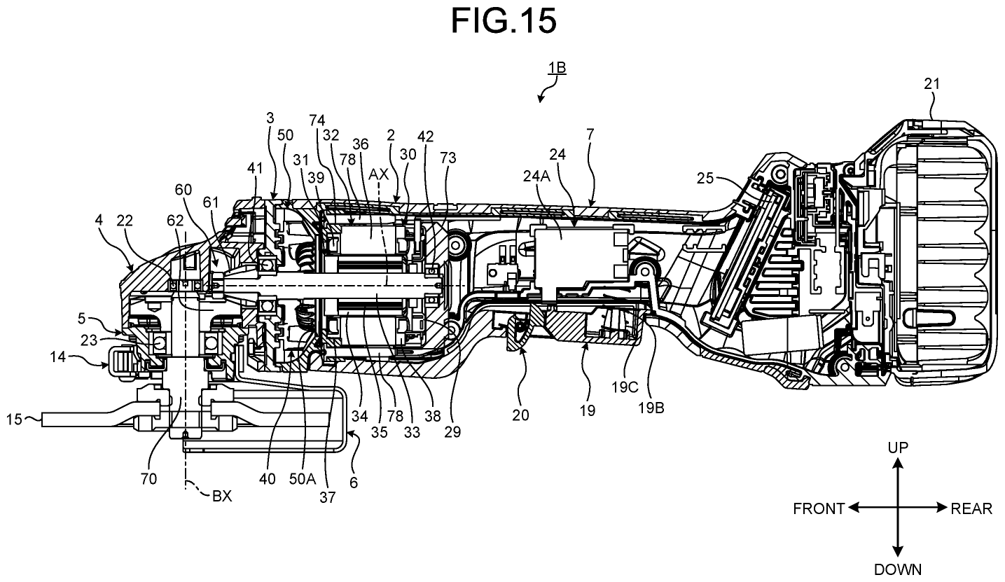

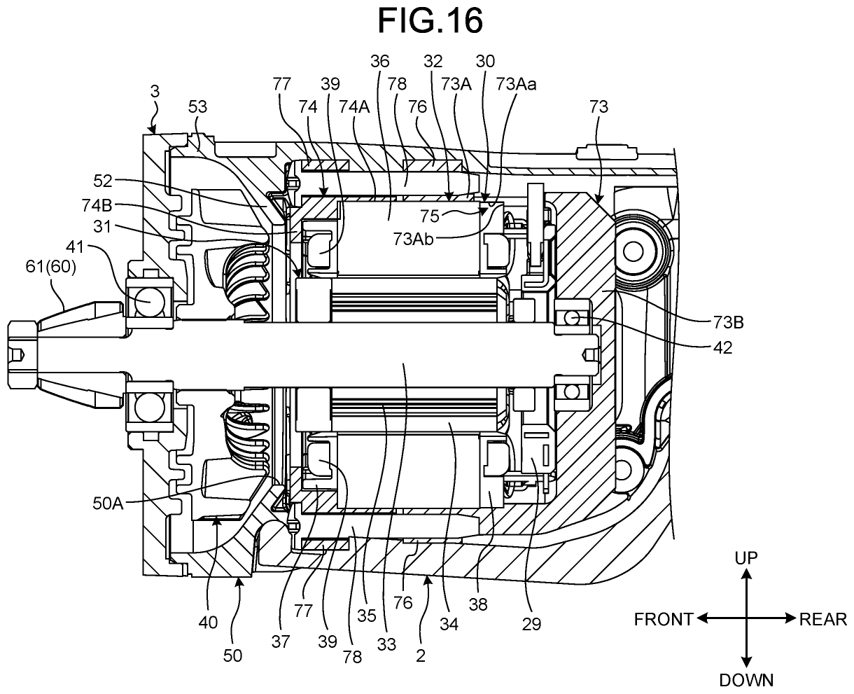

FIG. 14 is an oblique view that shows a power tool 1B according to the present embodiment. FIG. 15 is a cross-sectional view that shows the power tool 1B according to the present embodiment. FIG. 16 is a partial, enlarged, cross-sectional view of the power tool 1B according to the present embodiment.

As shown in FIG. 14, FIG. 15, and FIG. 16, the power tool 1B comprises the motor housing 2, the gear-housing cover 3, the gear housing 4, the bearing box 5, the wheel cover 6, the grip housing 7, the battery-mounting part 8, the motor 30, the centrifugal fan 40, the bearing 41, the bearing 42, the baffle 50, the power-transmission mechanism 60, and the spindle 70.

The motor housing 2 houses the motor 30, the centrifugal fan 40, and the baffle 50. The gear-housing cover 3 is disposed between the motor housing 2 and the gear housing 4. The gear housing 4 houses the power-transmission mechanism 60. In addition, the gear housing 4 houses an upper portion of the spindle 70.

The motor 30 comprises the rotor 31 and the stator 32, which is disposed around the rotor 31. The bearing 41 and the bearing 42 both support the rotary shaft 33 of the rotor 31 in a rotatable manner. The bearing 41 supports a front portion of the rotary shaft 33 in a rotatable manner. The bearing 42 supports a rear portion of the rotary shaft 33 in a rotatable manner.

The baffle 50 is supported by the motor housing 2. In the present embodiment, the baffle 50 does not hold the stator 32. The baffle 50 may be made of a metal or may be made of a synthetic resin.

In the present embodiment, the power tool 1B comprises: a holding member 73, which holds the bearing 42; and an encircling member 74, which is disposed around the stator 32 forward of the holding member 73. The bearing 41 is held by the gear-housing cover 3, which is made of a metal. The bearing 42 is held by the holding member 73, which is made of a metal.

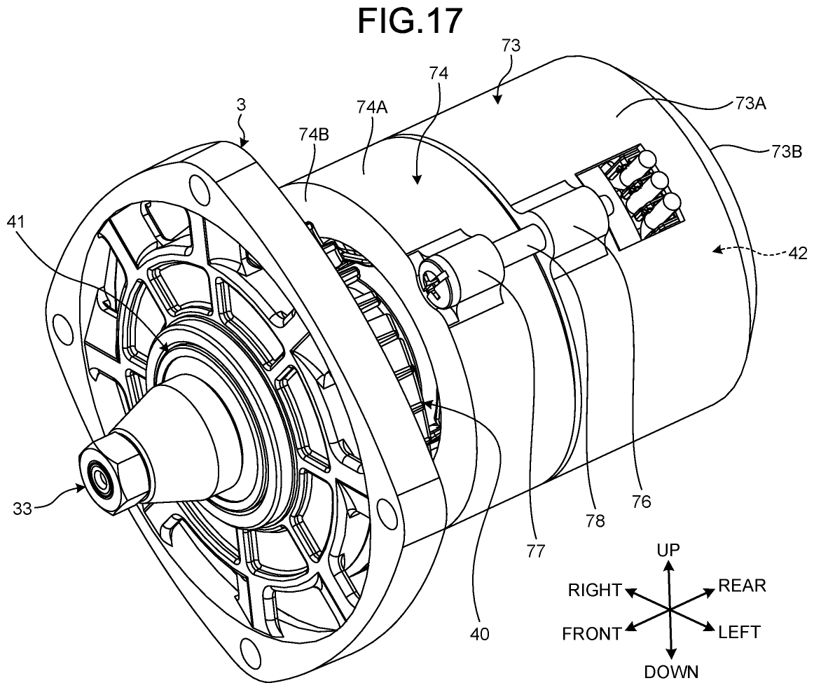

FIG. 17 is an oblique view that shows the holding member 73 and the encircling member 74 according to the present embodiment. As shown in FIG. 15, FIG. 16, and FIG. 17, the encircling member 74 is disposed forward of the holding member 73. The encircling member 74 is disposed between the gear-housing cover 3 and the holding member 73 in the axial direction. At least a portion of the baffle 50 is disposed between the gear-housing cover 3 and the encircling member 74 in the axial direction. It is noted that, in FIG. 17, illustration of the baffle 50 is omitted.

The holding member 73 and the encircling member 74 are housed in the motor housing 2. At least a portion of the holding member 73 is disposed around the stator 32. At least a portion of the encircling member 74 is disposed around the stator 32.

The holding member 73 is made of a metal such as aluminum. The holding member 73 has the functions of the stator-holding member, which holds the stator 32, and the bearing-retaining member, which retains the bearing 42. In the present embodiment, the holding member 73 is constituted by integrating the stator-holding member and the bearing-retaining member. The holding member 71 comprises a stator-holding part 73A, which holds the stator 32, and a bearing-retaining part 73B, which retains the bearing 42.

The stator-holding part 73A has a tube shape. The stator-holding part 73A is disposed around the stator core 36. The stator-holding part 73A makes contact with the stator core 36.

The stator-holding part 73A comprises a positioning part 75, which positions the stator 32. The positioning part 75 positions the stator 32 in the radial direction, the axial direction, and the circumferential direction. The positioning part 75 comprises an inner-circumferential surface 73Aa of the stator-holding part 73A, which contacts the outer-circumferential surface of the stator core 36, and a support surface 73Ab of the stator-holding part 73A, which contacts the rear-end surface of the stator core 36 (the rear insulator 38). The support surface 73Ab faces forward. By virtue of the stator core 36 being fitted in the interior of the stator-holding part 73A and by virtue of the inner-circumferential surface 73Aa of the stator-holding part 73A and the outer-circumferential surface of the stator core 36 making contact, the stator 32 is positioned in the radial direction and the circumferential direction. The stator 32 is positioned in the axial direction by the support surface 73Ab.

The bearing-retaining part 73B has a plate shape. The bearing-retaining part 73B is connected to a rear-end portion of the stator-holding part 73A. The bearing-retaining part 73B retains the bearing 42.

The encircling member 74 is made of a metal such as aluminum. The encircling member 74 is disposed such that it makes contact with the stator 32, and thereby resonance of the stator 32 is curtailed.

The encircling member 74 comprises: a tube part 74A, which is disposed around the stator 32 and at least a portion of which makes contact with the stator core 36; and a ring part 74B, which opposes the front-end surface of the stator 32.

The encircling member 74 tunes the resonance frequency of the vibration system that includes the stator 32 and the encircling member 74. At least one of the material, the stiffness, the weight, and the shape of the encircling member 74 may be tuned based on the resonance frequency of the stator 32. Resonance of the stator 32 is curtailed by the encircling member 74. By curtailing the resonance of the stator 32, generation of noise is curtailed.

The holding member 73 comprises protruding parts 76, which protrude outward in the radial direction from the outer-circumferential surface of the stator-holding part 73A. The encircling member 74 comprises protruding parts 77, which protrude outward in the radial direction from the outer-circumferential surface of the tube part 74A. In the present embodiment, two of the protruding parts 76 are provided. Two of the protruding parts 77 are provided.

Screw holes, which are joined with screws 78, are provided in the protruding parts 76. Openings, in which the screws 78 are disposed, are provided in the protruding parts 77. The holding member 73 and the encircling member 74 are fixed by the screws 78.

In the present embodiment as explained above, the bearing 41 is held by the gear-housing cover 3, which is made of a metal, and the bearing 42 is held by the holding member 73, which is made of a metal. In addition, the holding member 73 holds the stator 32. Even if the environment (humidity or temperature) in which the power tool 1B is used changes, deformation of the holding member 73 due to moisture absorption or heat is curtailed. Consequently, tilting of the rotor 31 relative to the stator 32 is curtailed. Accordingly, a gap is maintained between the rotor 31 and the stator 32, and thereby contact between the rotor 31 and the stator 32 is curtailed.

In addition, by virtue of the stator 32 being held by the encircling member 74, which is made of a metal, the resonance frequency of the vibration system that includes the stator 32 and the encircling member 74 is tuned. Consequently, generation of noise is curtailed during operation of the motor 30, because resonance of the stator 32 is curtailed.

In addition, because the holding member 73 and the encircling member 74, which make contact with the stator 32, are each made of a metal, a rise in the temperature of the motor 30 is curtailed during operation of the motor 30 owing to the heat-dissipating effect of the holding member 73 and the heat-dissipating effect of the encircling member 74.

The holding member 73 comprises the positioning part 75, which positions the stator 32. Thereby, changes in the relative position between the holding member 73 and the stator 32 are curtailed.

It is noted that, in the present embodiment, the stator-holding part 73A, which has a tube shape, and the bearing-retaining part 73B, which has a plate shape, may be separate bodies. The stator-holding part 73A and the bearing-retaining part 73B, as separate bodies, may be fixed by screws.

### Third Embodiment

A third embodiment will now be explained. In the explanation below, structural elements that are identical or equivalent to those in the embodiment described above are assigned identical symbols, and explanations thereof are abbreviated or omitted.

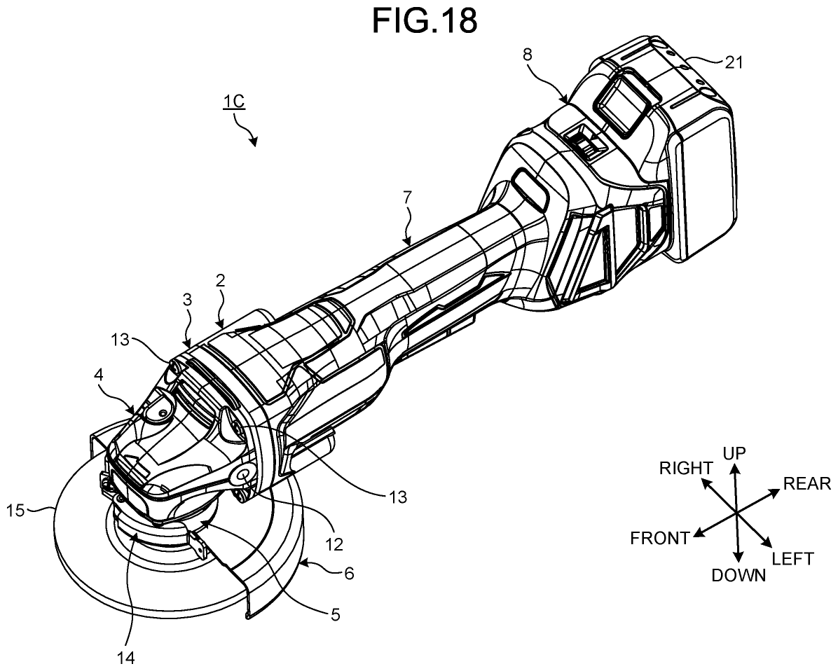

FIG. 18 is an oblique view that shows a power tool 1C according to the present embodiment. Like the embodiments described above, the power tool 1C comprises the motor housing 2, the gear-housing cover 3, the gear housing 4, the bearing box 5, the wheel cover 6, the grip housing 7, the battery-mounting part 8, etc.

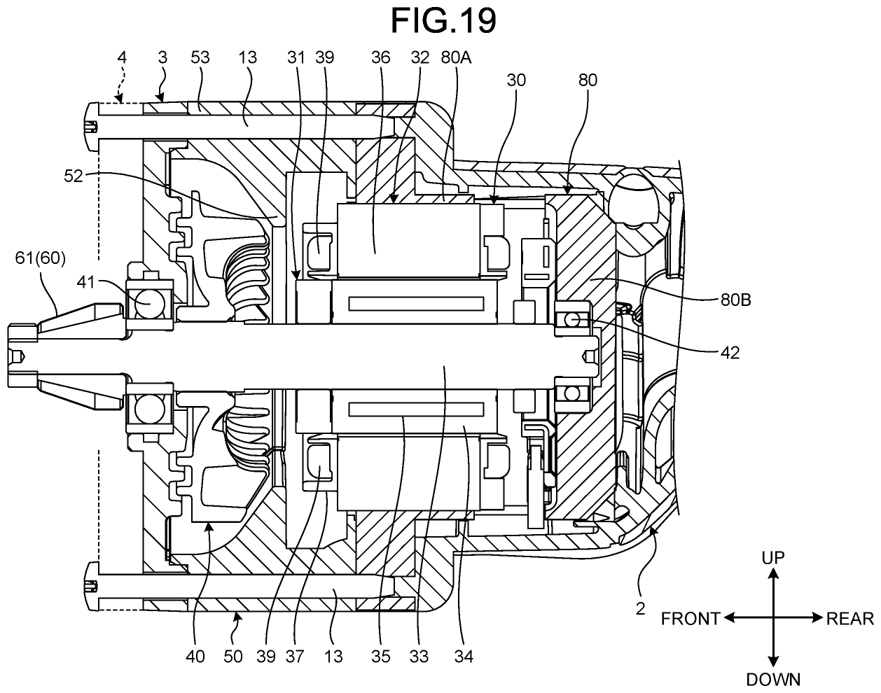

FIG. 19 is a partial, enlarged, cross-sectional view of the power tool 1C according to the present embodiment. As shown in FIG. 19, the power tool 1C comprises the motor 30, the centrifugal fan 40, the bearing 41, the bearing 42, and the baffle 50.

The gear-housing cover 3 is disposed between the motor housing 2 and the gear housing 4. The gear-housing cover 3 has a plate shape.

The motor 30 comprises the rotor 31 and the stator 32, which is disposed around the rotor 31. The bearing 41 and the bearing 42 both support the rotary shaft 33 of the rotor 31 in a rotatable manner. The bearing 41 supports a front portion of the rotary shaft 33 in a rotatable manner. The bearing 42 supports a rear portion of the rotary shaft 33 in a rotatable manner.

The baffle 50 is supported by the motor housing 2. In the present embodiment, the baffle 50 does not hold the stator 32. The baffle 50 may be made of a metal or may be made of a synthetic resin.

In the present embodiment, the power tool 1C comprises a holding member 80, which holds the bearing 42. The bearing 41 is held by the gear-housing cover 3, which is made of a metal. The bearing 42 is held by the holding member 80, which is made of a metal. The holding member 80 is fixed to the gear-housing cover 3. The gear-housing cover 3 functions as a first bearing-retaining member, which retains the bearing 41 (first bearing). The holding member 80 functions as a second bearing-retaining member, which retains the bearing 42 (second bearing).

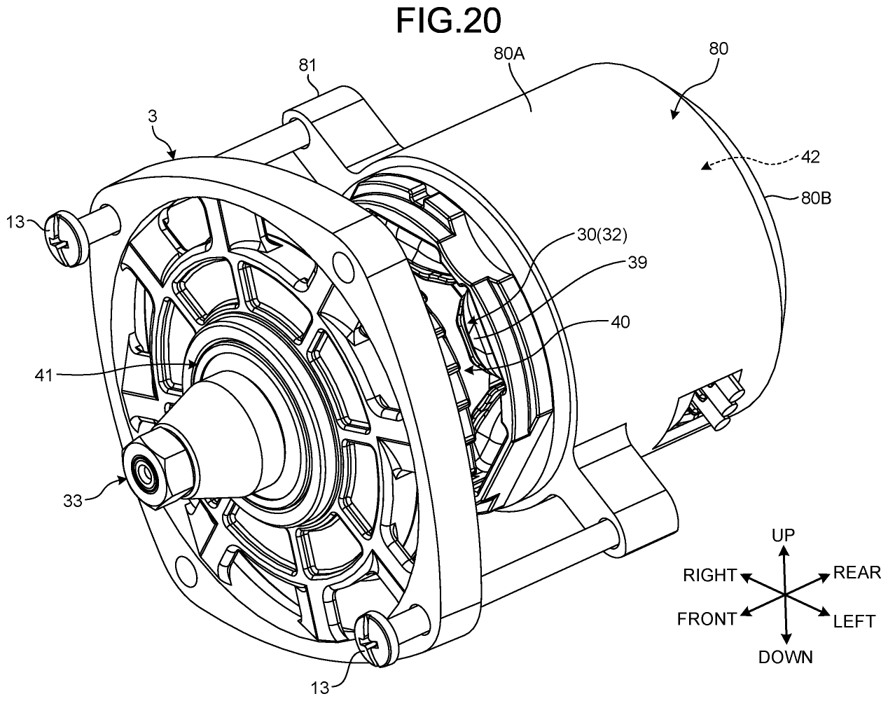

FIG. 20 is an oblique view that shows the gear-housing cover 3 and the holding member 80 according to the present embodiment. As shown in FIG. 19 and FIG. 20, the gear-housing cover 3 is disposed forward of the holding member 80. In the axial direction, at least a portion of the baffle 50 is disposed between the gear-housing cover 3 and the holding member 80. It is noted that, in FIG. 20, illustration of the baffle 50 is omitted.

The baffle 50 and the holding member 80 are housed in the motor housing 2. At least a portion of the holding member 80 is disposed around the stator 32.

The holding member 80 is made of a metal such as aluminum. The holding member 80 has the functions of the stator-holding member, which holds the stator 32, and the bearing-retaining member, which retains the bearing 42. In the present embodiment, the holding member 80 is constituted by integrating the stator-holding member and the bearing-retaining member. The holding member 80 comprises a stator-holding part 80A, which holds the stator 32, and a bearing-retaining part 80B, which retains the bearing 42.

The stator-holding part 80A has a tube shape. The stator-holding part 80A is disposed around the stator core 36. The stator-holding part 80A makes contact with the stator core 36. The stator-holding part 80A is positioned by the stator 32.

The bearing-retaining part 80B has a plate shape. The bearing-retaining part 80B is connected to a rear-end portion of the stator-holding part 80A. The bearing-retaining part 80B retains the bearing 42.

The gear-housing cover 3 is fixed to the stator-holding part 80A (stator-holding member). As shown in FIG. 20, the holding member 80 comprises protruding parts 81, which protrude outward in the radial direction from the outer-circumferential surface of the stator-holding part 80A. In the present embodiment, two of the protruding parts 81 are provided.

Screw holes, which are joined with the screws 13, are provided in the protruding parts 81. The gear-housing cover 3 and the stator-holding part 80A are fixed by the screws 13.

As shown in FIG. 18, the gear housing 4 and the gear-housing cover 3 are fixed by the screws 13. Although the gear housing 4 is not shown in FIG. 20, the gear housing 4, the gear-housing cover 3, and the holding member 80 are fixed by the screws 13.

In the present embodiment as explained above, the bearing 41 is held by the gear-housing cover 3, which is made of a metal, and the bearing 42 is held by the holding member 80, which is made of a metal. The gear-housing cover 3 and the holding member 80 are fixed by the screws 13. In addition, the holding member 80 holds the stator 32. Even if the environment (humidity or temperature) in which the power tool 1C is used changes, deformation of the holding member 80 and the gear-housing cover 3 due to moisture absorption or heat is curtailed. Consequently, tilting of the rotor 31 relative to the stator 32 is curtailed. Accordingly, a gap is maintained between the rotor 31 and the stator 32, and thereby contact between the rotor 31 and the stator 32 is curtailed.

It is noted that, in the present embodiment, the stator-holding part 80A, which has a tube shape, and the bearing-retaining part 80B, which has a plate shape, may be separate bodies. The stator-holding part 80A and the bearing-retaining part 80B, as separate bodies, may be fixed by screws.

### Fourth Embodiment

A fourth embodiment will now be explained. In the explanation below, structural elements that are identical or equivalent to those in the embodiment described above are assigned identical symbols, and explanations thereof are abbreviated or omitted.

In the first embodiment described above, it was assumed that the baffle 50 is made of a metal. Because the water-absorption coefficient of metal is low, even if the environment (humidity) in which the power tool 1A is used changes, deformation of the baffle 50 due to moisture absorption is curtailed. Consequently, it was assumed that the baffle 50 is preferably made of a metal instead of a synthetic resin whose water-absorption coefficient is high. It is noted that the baffle 50 does not have to be made of a metal. The baffle 50 may be made of a synthetic resin whose water-absorption coefficient is low. By forming the baffle 50 using a synthetic resin whose water-absorption coefficient is low, even if the environment (humidity) in which the power tool 1A is used changes, deformation of the baffle 50 due to moisture absorption is curtailed. By virtue of deformation of the baffle 50 due to moisture absorption being curtailed, tilting of the rotor 31 relative to the stator 32 is curtailed. Consequently, a gap is maintained between the rotor 31 and the stator 32, and thereby contact between the rotor 31 and the stator 32 is curtailed.

In the present embodiment, a synthetic resin whose water-absorption coefficient is low means a synthetic resin whose water-absorption coefficient at equilibrium is low. Water-absorption coefficient at equilibrium means the water-absorption coefficient when a sample of the synthetic resin has been held stationary in an ambient atmosphere at a constant temperature and constant humidity and the moisture contained in the sample has reached the state of equilibrium.

In the present embodiment, a synthetic resin whose water-absorption coefficient at equilibrium is low means a synthetic resin whose water-absorption coefficient at equilibrium is 1.5 wt % or less in an ambient atmosphere at a temperature of 23° C. and a relative humidity (RH: relative humidity) of 50%. The water-absorption coefficient at equilibrium is calculated by holding stationary a sample of the synthetic resin, which has been dried at 160° C. or lower, for 500 h or longer in a constant-temperature, constant-humidity tank in an ambient atmosphere at a temperature of 23° C. and a relative humidity of 50%, and then dividing the difference between the weight of the sample before water absorption at equilibrium and the weight of the sample after water absorption at equilibrium by the weight of the sample before water absorption at equilibrium. That is, the water-absorption coefficient at equilibrium is calculated by Equation (1) below.

[Water-Absorption Coefficient at Equilibrium (%)]=[(Weight of Sample after Water Absorption at Equilibrium)−(Weight of Sample before Water Absorption at Equilibrium)]/(Weight of Sample before Water Absorption at Equilibrium)×100 (1)

Nylon 610 (PA610-GF30) filled with glass fibers to 30%, polycarbonate (PC), polycarbonate (PC-GF15) filled with glass fibers to 15%, and polyacetal (POM) are illustrative examples of synthetic resins whose water-absorption coefficient at equilibrium are low.

The water-absorption coefficient at equilibrium of PA610-GF30 in an ambient atmosphere at a temperature of 23° C. and a relative humidity of 50% is 0.8 wt % or more and 1.2 wt % or less.

The water-absorption coefficient at equilibrium of PC in an ambient atmosphere at a temperature of 23° C. and a relative humidity of 50% is 0.10 wt % or more and 0.15 wt % or less.

The water-absorption coefficient at equilibrium of PC-GF15 in an ambient atmosphere at a temperature of 23° C. and a relative humidity of 50% is 0.05 wt % or more and 0.10 wt % or less.

The water-absorption coefficient at equilibrium of POM in an ambient atmosphere at a temperature of 23° C. and a relative humidity of 50% is 0.1 wt % or more and 0.3 wt % or less.

PA610-GF30, PC, PC-GF15, and POM are all synthetic resins whose water-absorption coefficient at equilibrium in an ambient atmosphere at a temperature of 23° C. and a relative humidity of 50% is 1.5 wt % or less.

It is noted that the water-absorption coefficient at equilibrium of metal in an ambient atmosphere at a temperature of 23° C. and a relative humidity of 50% is 1.5 wt % or less. The water-absorption coefficient at equilibrium of metal is substantially 0 wt %.

By virtue of the baffle 50 being made of a material whose water-absorption coefficient at equilibrium in an ambient atmosphere at a temperature of 23° C. and a relative humidity of 50% is 1.5 wt % or less, moisture absorption of the baffle 50 is curtailed. Accordingly, deformation of the baffle 50 due to moisture absorption is curtailed.

PA610-GF30 has high strength and chemical resistance. Consequently, the baffle 50 used in a grinder may be made of nylon 610, which is filled with glass fibers to 30%. In addition, PC and PC-GF15 have a sufficiently low water-absorption coefficient at equilibrium and excel in impact resistance. Consequently, the baffle 50 may be made of polycarbonate or polycarbonate filled with glass fibers to 15%.

It is noted that the material that forms the baffle 50 may be a material whose water-absorption coefficient at equilibrium in an ambient atmosphere at a temperature of 23° C. and a relative humidity (RH: relative humidity) of 50% is 1.2 wt % or less.

It is noted that synthetic resins having a low water-absorption coefficient may be a synthetic resin having a low water-absorption coefficient at saturation. Water-absorption coefficient at saturation means the water-absorption coefficient when a sample of the synthetic resin is held stationary in water at a constant temperature and the moisture contained in that sample has reached the state of equilibrium.

In the present embodiments, synthetic resins whose water-absorption coefficient at saturation are low mean a synthetic resin whose water-absorption coefficient at saturation in water at a temperature of 23° C. is 3.0 wt % or less. The water-absorption coefficient at saturation is calculated, in accordance with ASTM-D570 (ISO62, JIS K 7209), by immersing a sample of the synthetic resin, which has been dried at 160° C. or lower, for 24 h or longer in water at a temperature of 23° C. and dividing the difference between the weight of the sample before water absorption at saturation and the weight of the sample after water absorption at saturation by the weight of the sample before water absorption at saturation. That is, the water-absorption coefficient at saturation is calculated by Equation (2) below.

[Water-Absorption Coefficient at Saturation (%)]=[(Weight of Sample after Water Absorption at Saturation)−(Weight of Sample before Water Absorption at Saturation)]/(Weight of Sample before Water Absorption at Saturation)×100 (2)

PA610-GF30, PC, PC-GF15, and POM described above are illustrative examples of synthetic resins whose water-absorption coefficient at saturation are low. In addition, polypropylene (PP), acrylonitrile butadiene styrene (ABS), and high-density polyethylene (HDPE) are illustrative examples of synthetic resin whose water-absorption coefficient at saturation are low.

The water-absorption coefficient at saturation of PA610-GF30 in water at a temperature of 23° C. is 2.0 wt % or more and 2.6 wt % or less.

The water-absorption coefficient at saturation of PC in water at a temperature of 23° C. is 0.2 wt % or more and 0.3 wt % or less.

The water-absorption coefficient at saturation of PC-GF15 in water at a temperature of 23° C. is 0.1 wt % or more and 0.2 wt % or less.

The water-absorption coefficient at saturation of POM in water at a temperature of 23° C. is 0.65 wt % or more and 0.90 wt % or less.

The water-absorption coefficient at saturation of PP in water at a temperature of 23° C. is 0.05 wt % or more and 0.10 wt % or less.

The water-absorption coefficient at saturation of ABS in water at a temperature of 23° C. is 0.25 wt % or more and 0.35 wt % or less.

The water-absorption coefficient at saturation of HDPE in water at a temperature of 23° C. is 0.05 wt % or more and 0.10 wt % or less.

PA610-GF30, PC, PC-GF15, POM, PP, ABS, and HDPE are all synthetic resins whose water-absorption coefficient at saturation in water at a temperature of 23° C. is 3.0 wt % or less.

It is noted that the water-absorption coefficient at saturation of metal in water at a temperature of 23° C. is 3.0 wt % or less. The water-absorption coefficient at saturation of metal is substantially 0 wt %.

By virtue of the baffle 50 being made of a material whose water-absorption coefficient at saturation in water at a temperature of 23° C. is 3.0 wt % or less, moisture absorption of the baffle 50 is curtailed. Accordingly, deformation of the baffle 50 due to moisture absorption is curtailed.

It is noted that the material that forms the baffle 50 may be a material whose water-absorption coefficient at saturation in water at a temperature of 23° C. is 2.6 wt % or less.

It is noted that the holding member 71 explained with reference to FIG. 12 may be formed of the synthetic resins, described above, whose water-absorption coefficient at equilibrium or water-absorption coefficient at saturation is low. The holding member 72 explained with reference to FIG. 13 may be formed of the synthetic resins, described above, whose water-absorption coefficient at equilibrium or water-absorption coefficient at saturation is low. The holding member 73 explained with reference to FIG. 14 to FIG. 17 may be formed of the synthetic resins, described above, whose water-absorption coefficient at equilibrium or water-absorption coefficient at saturation is low. The holding member 80 explained with reference to FIG. 18 to FIG. 20 may be formed of the synthetic resins, described above, whose water-absorption coefficient at equilibrium or water-absorption coefficient at saturation is low.

### Other Embodiments

It is noted that, in the embodiments described above, it was assumed that the power tool is a grinder. The power tool is not limited to being a grinder. Driver-drills, angle drills, impact drivers, hammers, hammer drills, circular saws, and reciprocating saws are illustrative examples of a power tool.

In the embodiments described above, it was assumed that the electric work machine is a power tool. The electric work machine is not limited to being a power tool. A gardening tool is an illustrative example of an electric work machine. A chain saw, a hedge trimmer, a lawn mower, a mowing machine, and a blower are illustrative examples of gardening tools.

In the embodiments described above, it was assumed that the battery pack(s) 21, which is (are) mounted on the battery-mounting part(s) 8, is (are) used as the power supply of the electric work machine. A commercial power supply (AC power supply) may be used as the power supply of the electric work machine.

### EXPLANATION OF THE REFERENCE NUMBERS

1A Power tool
1B Power tool
1C Power tool
2 Motor housing
2A Housing part
2B Outer-tube part
2C Stop part
2D Inner-tube part
2E Protruding part
2F Inner surface
2G Support surface
2H Screw hole
2I Screw hole
3 Gear-housing cover
3A Recessed part
3B Opening
3C Opening
3M Vent
3S Opening
4 Gear housing
4A Plate part
4B Opening
4S Opening
5 Bearing box
6 Wheel cover
7 Grip housing
7A Upper housing
7B Lower housing
7C Screw boss
8 Battery-mounting part
9A Air-suction port
9B Air-exhaust port
10 Lock switch
11 Side handle
12 Screw hole
13 Screw
14 Clamp mechanism
15 Tool accessory
16 Grip part
17 Connecting part
18 Controller-housing part
19 Switch lever
19A Hinge
19B Spring
19C Projection part
20 Lock-OFF lever
20A Protruding part
21 Battery pack
22 Bearing
23 Bearing
24 Switch apparatus
24A Casing
24B Plunger
25 Controller
26 Recessed part
27 Projection part
28 Sensor circuit board
29 Short-circuiting member
29A Screw
30 Motor
31 Rotor
32 Stator
33 Rotary shaft
34 Rotor core
35 Permanent magnet
36 Stator core
37 Front insulator
38 Rear insulator
39 Coil
40 Centrifugal fan
41 Bearing
42 Bearing
43 Screw
44 Positioning part
50 Baffle
50A Opening
50B Opening
51 Tube part
51A Inner-circumferential surface
51B Support surface
52 Opposing part
53 Circumferential-wall part
54 Positioning part
55 Protruding part
60 Power-transmission mechanism
61 First bevel gear
62 Second bevel gear
70 Spindle
71 Holding member
71A Stator-holding part
71B Bearing-retaining part
71C Opposing part
71D Circumferential-wall part
72 Holding member
72A Stator-holding part
72B Bearing-retaining part
72C Opposing part
72D Circumferential-wall part
72E Housing part
73 Holding member
73A Stator-holding part
73 Aa Inner-circumferential surface
73Ab Support surface
73B Bearing-retaining part
74 Encircling member
74A Tube part
74B Ring part
75 Positioning part
76 Protruding part
77 Protruding part
78 Screw
80 Holding member
80A Stator-holding part
80B Bearing-retaining part
81 Protruding part

1. An electric work machine comprising:
a motor comprising a rotor and a stator, which is disposed around the rotor;
a stator-holding member, which holds the stator;
a bearing, which supports the rotor in a rotatable manner; and
a bearing-retaining member, which is supported by the stator-holding member in an immovable manner in the radial direction, retains the bearing, and is made of a metal;
wherein the stator-holding member is made of a material whose water-absorption coefficient at equilibrium in an ambient atmosphere at a temperature of 23° C. and a relative humidity of 50% is 1.5 wt % or less.

2. The electric work machine according to claim 1, wherein the stator-holding member comprises a positioning part, which positions the stator.

3. The electric work machine according to claim 1, wherein the stator-holding member comprises:
a tube part, which contacts the stator, and
an opposing part, which opposes an end surface of the stator in the axial direction.

4. The electric work machine according to claim 1, further comprising:
a centrifugal fan, which rotates in response to rotation of the rotor; and
a baffle, which guides air that is circulated by the centrifugal fan;
wherein the stator-holding member comprises the baffle.

5. The electric work machine according to claim 1, further comprising:
a spindle, which rotates in response to rotation of the rotor;
a motor housing, which houses the motor and the stator-holding member;
a gear housing, which houses at least a portion of the spindle; and
a gear-housing cover, which is disposed between the motor housing and the gear housing;
wherein the bearing-retaining member comprises the gear-housing cover.

6. The electric work machine according to claim 1, wherein the stator-holding member and the bearing-retaining member are integral.

7. The electric work machine according to claim 1, further comprising:
an encircling member disposed so as to contact the stator and curtail resonance of the stator.

8. The electric work machine according to claim 1, wherein:
the bearing comprises a first bearing, which supports a front portion of a rotary shaft of the rotor, and a second bearing, which supports a rear portion of the rotary shaft;
the bearing-retaining member comprises a first bearing-retaining member, which retains the first bearing, and a second bearing-retaining member, which retains the second bearing; and
the first bearing-retaining member and the second bearing-retaining member are fixed by a screw.

9. The electric work machine according to claim 1, wherein the stator-holding member is made of nylon 610 having 30 wt % glass fibers.

10. The electric work machine according to claim 1, wherein the stator-holding member is made of polycarbonate or of polycarbonate having 15 wt % glass fibers.

11. The electric work machine according to claim 1, wherein the stator-holding member is made of a metal.

12. An electric work machine comprising:
a motor comprising a rotor and a stator, which is disposed around the rotor;
a stator-holding member, which holds the stator and is made of a metal;
a bearing, which supports the rotor in a rotatable manner; and
a bearing-retaining member, which is supported by the stator-holding member in an immovable manner in the radial direction, retains the bearing, and is made of a metal.

13. The electric work machine according to claim 12, wherein:
the bearing comprises a first bearing, which supports a front portion of a rotary shaft of the rotor, and a second bearing, which supports a rear portion of the rotary shaft;
the bearing-retaining member comprises a first bearing-retaining member, which retains the first bearing, and a second bearing-retaining member, which retains the second bearing; and
the first bearing-retaining member and the second bearing-retaining member are fixed by a screw.

14. The electric work machine according to claim 8, wherein the stator-holding member comprises a positioning part, which positions the stator.

15. The electric work machine according to claim 14, wherein the stator-holding member comprises:
a tube part, which contacts the stator, and
an opposing part, which opposes an end surface of the stator in the axial direction.

16. The electric work machine according to claim 15, further comprising:
a centrifugal fan, which rotates in response to rotation of the rotor; and
a baffle, which guides air that is circulated by the centrifugal fan;
wherein the stator-holding member comprises the baffle.

17. The electric work machine according to claim 16, further comprising:
a spindle, which rotates in response to rotation of the rotor;
a motor housing, which houses the motor and the stator-holding member;
a gear housing, which houses at least a portion of the spindle; and
a gear-housing cover, which is disposed between the motor housing and the gear housing;
wherein the bearing-retaining members comprise the gear-housing cover.

18. The electric work machine according to claim 15, wherein the stator-holding member and the bearing-retaining members are integral.

19. The electric work machine according to claim 15, further comprising:
an encircling member disposed so as to contact the stator and curtail resonance of the stator.

20. The electric work machine according to claim 15, wherein the stator-holding member is made of:
nylon 610 having up to 30 wt % glass fibers; or
polycarbonate having up to 15 wt % glass fibers; or
a metal.
